(19) United States
(12) Patent Application Publication
(10) Pub. No.: US 2016/0231971 A1
(43) Pub. Date: Aug. 11, 2016

(54) INFORMATION PROCESSING DEVICE, MANAGEMENT DEVICE, CONTROL METHOD FOR INFORMATION PROCESSING DEVICE, CONTROL METHOD FOR MANAGEMENT DEVICE, AND PROGRAM

(71) Applicant: CANON KABUSHIKI KAISHA, Tokyo (JP)

(72) Inventor: Tetsuya Sato, Yokohama-shi (JP)

(21) Appl. No.: 15/018,624

(22) Filed: Feb. 8, 2016

(30) Foreign Application Priority Data
Feb. 10, 2015 (JP) 2015-024638

(51) Int. Cl. G06F 3/12; H04N 1/00

(52) U.S. Cl. CPC G06F 3/1258; H04N 1/00344; H04N 1/00204; G06F 3/1204; G06F 3/1254; G06F 3/1288; H04N 2201/0094

(57) ABSTRACT

An information processing device which communicates with a management device executes a predetermined setting in accordance with case information acquired from the management device. When notifying the management device of an executed operation state, the operation state of the information processing device that the management device manages is updated. Then, for the next information processing device, an operator acquires an operation state of a different information processing device to be updated by the management device and displays the acquired operation state on a display unit, so that a setting state of each information processing device may be confirmed.

### BACKGROUND OF THE INVENTION

1. Field of the Invention

The present invention relates to an information processing device, a management device, a control method for an information processing device, a control method for a management device, and a program.

2. Description of the Related Art

For new introduction of an information processing device, for example, an image forming device such as a multifunction peripheral (MFP) or a single-function printer (SFP), an installation operation corresponding to a use environment at a customer site has been required. Such an installation operation for an image forming device has taken significant time and effort. Therefore, in the case where a plurality of image forming devices require similar installation operations, software, setting values, data for validation, and the like which are necessary for a use environment have been prepared in advance.

A system which performs an installation operation automatically and efficiently by causing an image forming device to process the above prepared software, values, data, and the like in accordance with operation instruction information of the installation operation, has been suggested.

For such an automatic installation operation, there are still some manual operations to be performed by a person in charge of installation, such as an operation to be performed in the middle of the automatic installation operation and an operation for printing and confirming the result of the installation operation after the automatic installation operation is completed. Therefore, the person in charge of installation needs to confirm the operation state of the automatic installation operation. A system which displays the operation state of an operation that is being performed by a device on a user interface (UI) of the device has been suggested (Japanese Patent Laid-Open No. 2007-160674).

However, since an automatic installation operation for an image forming device requires a long time, if there is a need to perform installation operations for a plurality of image forming devices, when an automatic installation operation for the first image forming device starts, a person in charge of installation moves onto an installation operation for the next image forming device. That is, the person in charge of installation moves away from the site of the first image forming device. Therefore, the system disclosed in Japanese Patent Laid-Open No. 2007-160674 in which the operation state of a device is displayed on a UI of the device cannot cope with the above case.

### SUMMARY OF THE INVENTION

The present invention has been made to solve the above problem, and provides a mechanism for allowing a person in charge of installation to confirm the operation state of an information processing device even when the person in charge of installation moves away from the location of the information processing device, for example, in the case where installation operations for a plurality of information processing devices need to be performed.

An information processing device according to an embodiment of the present invention which communicates with a management device includes an execution unit configured to execute a predetermined setting in accordance with case information acquired from the management device; a first notification unit configured to notify the management device of an operation state executed by the execution unit; and a controller configured to acquire an operation state of a different information processing device updated by the management device and display the acquired operation state on a display unit.

A management device according to an embodiment of the present invention which communicates with a plurality of information processing devices includes a management unit configured to store and manage case information to be set for the plurality of information processing devices and case information updated in accordance with a response from any of the information processing devices; and a response unit configured to respond with case information requested from any of the information processing devices.

Further features of the present invention will become apparent from the following description of exemplary embodiments with reference to the attached drawings.

### BRIEF DESCRIPTION OF THE DRAWINGS

FIG. 1 illustrates a configuration example of a system to which an information processing device and a management device are applied.

FIGS. 2A and 2B are block diagrams illustrating configurations of an MFP and a client computer.

FIGS. 3A and 3B are diagrams illustrating configurations of a case management server and a software management server.

FIGS. 4A and 4B are diagrams for explaining configurations of software of an MFP

FIGS. 5A and SB are diagrams illustrating configurations of software of the system illustrated in FIG. 1.

FIGS. 6A, 6B, 6C, and 6D are diagrams illustrating tables in a data storage unit and an operation state table.

FIG. 7 is a workflow diagram illustrating a basic operation flow.

FIGS. 8A and 8B are diagrams illustrating UI screens displayed on a client computer.

FIG. 9 is a diagram illustrating an example of an installation script in which an installation operation procedure is described.

FIGS. 10A and 10B are diagrams illustrating examples of a UI displayed on an operation unit of an MFP.

FIGS. 11A and 11B are diagrams illustrating a process of an automatic installation operation executed by an automatic installation program.

FIG. 12 is a flowchart for explaining a control method for a management device.

FIGS. 13A, 13B, and 13C are flowcharts illustrating a control method for an information processing device.

FIG. 14 is a diagram for explaining an example of operation state data.

FIGS. 15A, 15B, and 15C are diagrams illustrating examples of a UI screen displayed on an information processing device.

FIGS. 16A and 16B are diagrams illustrating configurations of a case management server program and a data storage unit.

FIGS. 17A and 17B are diagrams for explaining an installation script in which an installation operation procedure is described.

FIGS. 18A and 18B are diagrams for explaining operation state data and an event addition process.

FIG. 19 is a flowchart for explaining a control method for an information processing device.

FIGS. 20A and 20B are diagrams illustrating examples of a UI screen displayed on an information processing device.

FIGS. 21A and 21B are flowcharts for explaining a control method for an information processing device.

FIGS. 22A and 22B are diagrams illustrating examples of a UI screen displayed on an information processing device.

### DESCRIPTION OF THE EMBODIMENTS

Preferred embodiments of the present invention will be described with reference to the drawings.

### Explanation of System Configuration

### First Embodiment

### System Configuration

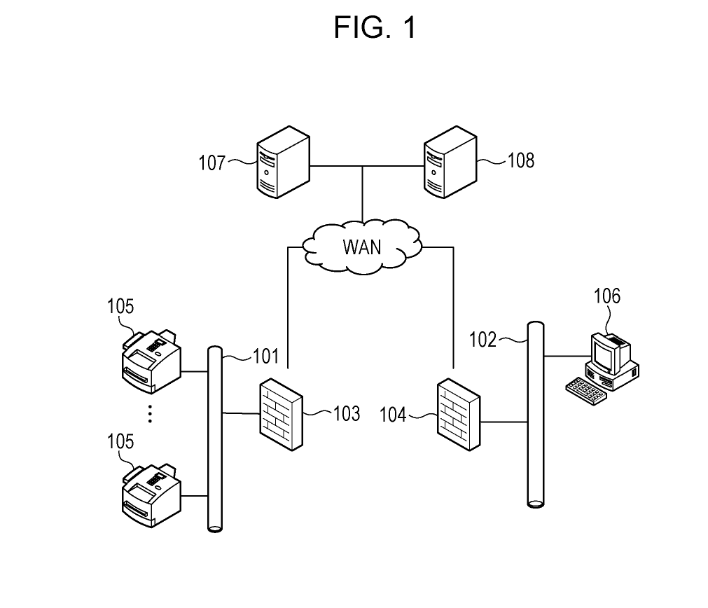

FIG. 1 is a diagram illustrating a configuration example of a system to which an information processing device and a management device according to a first embodiment of the present invention are applied. In the first embodiment, an MFP, which will be described below, will be explained as an example of an information processing device which performs a predetermined process.

Referring to FIG. 1, an automatic installation system includes a local area network (LAN) 101 and a LAN 102, which are independent of each other. Devices connected to the LAN 101 and the LAN 102 are connected to servers on the Internet via a wide area network (WAN) through firewalls 103 and 104. The LAN 101 is under a customer environment for installation, and a plurality of MFPs 105 are connected to the LAN 101.

The MFPs 105 perform installation under a customer environment. The MFPs 105 are image forming devices in which multiple functions such as a scanner, a printer, a facsimile, and a file transmission function are integrated with a copying machine. The MFPs 105 are not originally connected to the LAN 101. The MFPs 105 are connected to the LAN 101 during an installation operation, which will be described later. In the first embodiment, automatic installation of the MFPs 105 will be described. Although an MFP is explained as an example of an image forming device in the first embodiment, a different type such as an SFP may be used.

The LAN 102 is under an environment for preparation for installation, and a client computer 106 is connected to the LAN 102.

The client computer 106 is an information processing device such as, a so-called personal computer.

A case management server 107 is a server which manages case data, which is generated using the client computer 106 and in which the setting contents of the MFPs 105 are registered. The case data will be described later.

A software management server 108 is a server which manages firmware and various types of license information which may be used at the MFPs 105.

### <MFP>

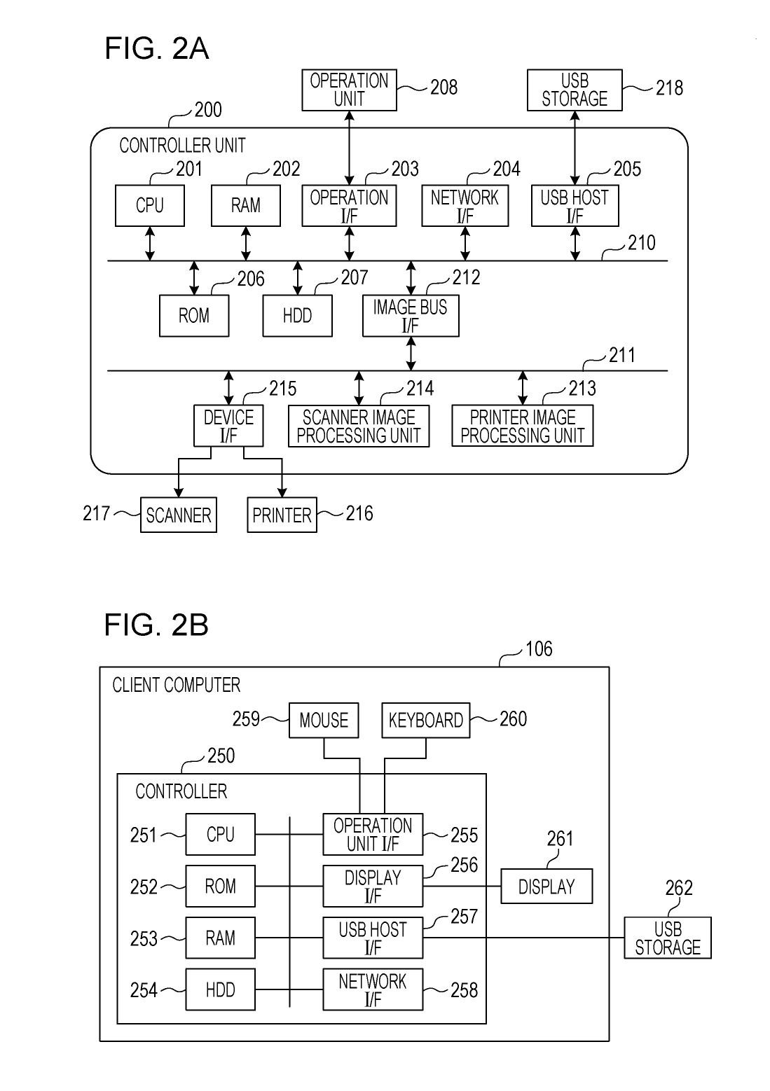

FIGS. 2A and 2B are block diagrams for explaining configurations of the MFP 105 and the client computer 106. In particular, FIG. 2A illustrates an example of the configuration of a main part of the MFP 105.

Referring to FIG. 2A, the MFP 105 includes a controller unit 200. A scanner 217, which is an image input device, and a printer 216, which is an image output device, are connected to the controller unit 200. In addition, an operation unit 208 is also connected to the controller unit 200. The controller unit 200 performs control for implementing a copy function of printing and outputting, with the printer 216, image data read by the scanner 217.

The controller unit 200 includes a central processing unit (CPU) 201, which is a processor. The CPU 201 activates an operation system (OS) through a boot program stored in a read only memory (ROM) 206. The CPU 201 executes a program stored in a hard disk drive (HDD) on the OS, and executes various processes through the program. A random access memory (RAM) 202 is used as an operation area of the CPU 201. The RAM 202 provides the operation area and also provides an image memory area for temporarily storing image data. The HDD 207 stores the above program and image data. The ROM 206, the RAM 202, and an operation unit interface (I/F) 203 are connected to the CPU 201 via a system bus 210. In addition, a network interface (network I/F) 204, a universal serial bus (USB) host I/F 205, and an image bus interface (image bus I/F) 212 are also connected to the CPU 201.

The operation unit I/F 203 is an interface with the operation unit 208 which includes a touch panel, and outputs image data to be displayed on the operation unit 208 to the operation unit 208. The operation unit I/F 203 also sends information input by a user through the operation unit 208 to the CPU 201. The network I/F 204 is an interface through which the MFP 105 is connected to a LAN. The USB host I/F 205 is an interface unit which communicates with a USB storage 218. The USB host I/F 205 outputs data stored in the HDD 207 to the USB storage 218. The USB host I/F 205 also receives data stored in the USB storage 218, and delivers the data to the CPU 201. The USB storage 218 is an external storage device which stores data, and is removable from the USB host I/F 205. The image bus I/F 212 is a bus bridge which allows connection between the system bus 210 and an image bus 211 for transferring image data at high speed and performs conversion of a data format. The image bus 211 is, for example, a peripheral component interconnect (PCI) bus or IEEE 1394. A device I/F 215, a scanner image processing unit 214, and a printer image processing unit 213 are provided on the image bus 211. The scanner 217 and the printer 216 are connected to the device I/F 215, and the device I/F 215 performs synchronous/asynchronous conversion of image data. The scanner image processing unit 214 corrects, processes, and edits input image data. The printer image processing unit 213 performs correction, resolution conversion, and the like corresponding to the printer 216 on print output image data.

### <Client Computer>

FIG. 2B illustrates a configuration of the client computer 106.

Referring to FIG. 2B, a controller 250 which includes a CPU 251 controls an overall operation of the client computer 106. The CPU 251 reads a control program stored in a ROM 252 and executes various control processes. A RAM 253 is used as a temporary storage area such as a main memory and a work area of the CPU 251. An HDD 254 stores image data and various programs. An operation unit I/F 255 is an interface which allows connection of a user interface terminal for inputting a control operation to a program executed at the client computer 106. In the first embodiment, the user interface terminal includes a mouse 259 and a keyboard 260. However, the user interface terminal is not limited to this. A display I/F 256 is an interface which allows connection of a display terminal for displaying a UI of a program executed at the client computer 106. In the first embodiment, the display terminal includes a display 261. However, the display terminal is not limited to this. A network I/F 258 allows connection between the controller 250 and a LAN. The network I/F 258 transmits and receives various types of information to and from a different device via a network. A USB host I/F 257 is an interface unit which communicates with a USB storage 262. The USB host I/F 257 outputs data stored in the HDD 254 to the USB storage 262.

The USB host I/F 257 also receives data stored in the USB storage 262 and delivers the data to the CPU 251. The USB storage 262 is an external storage device which stores data, and is removable from the USB host I/F 257.

### <Server>

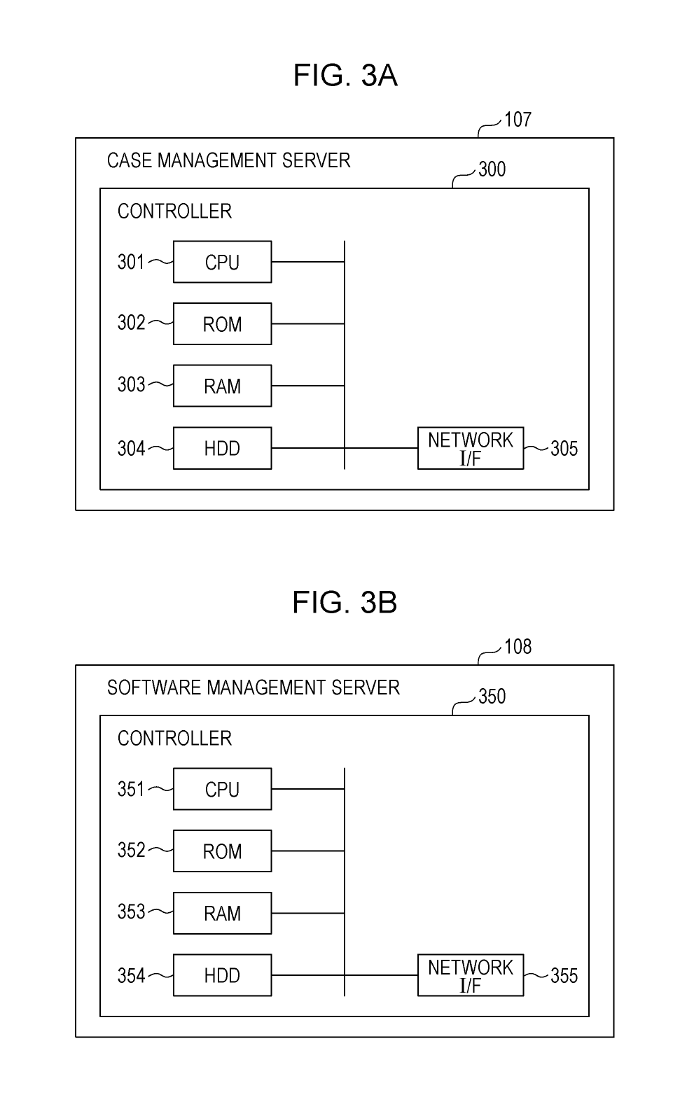

FIGS. 3A and 3B are block diagrams for explaining configurations of the case management server 107 and the software management server 108 illustrated in FIG. 1. In particular, FIG. 3A illustrates a configuration of the case management server 107.

Referring to FIG. 3A, a controller 300 which includes a CPU 301 controls an overall operation of the case management server 107. The CPU 301 reads a control program stored in a ROM 302 and executes various control processes. A RAM 303 is used as a temporary storage area such as a main memory and a work area of the CPU 301. An HDD 304 stores image data, various programs, or various information tables which will be described later. A network I/F 305 allows connection between the controller 300 and a LAN. The network I/F 305 transmits and receives various types of information to and from a different device via a network.

FIG. 3B illustrates a configuration of the software management server 108.

Referring to FIG. 3B, a controller 350 which includes a CPU 351 controls an overall operation of the case management server 107. The CPU 351 reads a control program stored in a ROM 352 and executes various control processes. A RAM 353 is used as a temporary storage area such as a main memory and a work area of the CPU 351. An HDD 354 stores image data, various programs, or various information tables which will be described later. A network I/F 355 allows connection between the controller 350 and a LAN. The network I/F 355 transmits and receives various types of information to and from a different device via a network.

### <Example of Software Configuration of MFP>

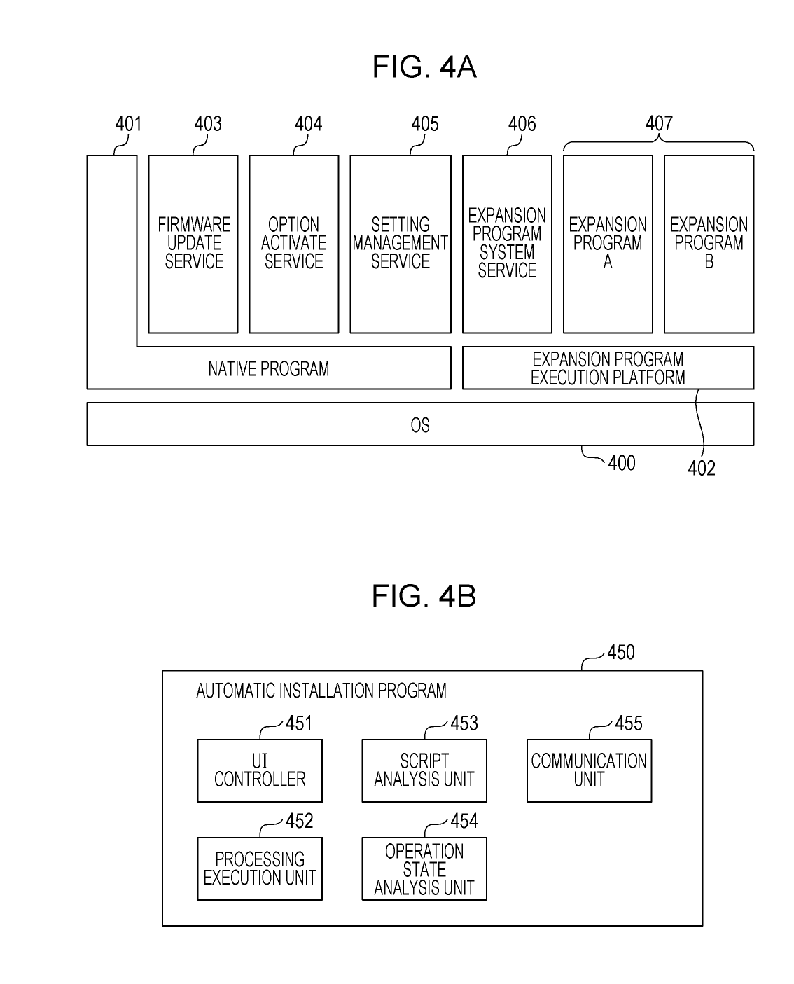

FIGS. 4A and 4B are diagrams for explaining a software configuration of the MFP 105 illustrated in FIG. 1.

Referring to FIG. 4A, a native program 401, which is an originally provided control program such as a printer, a FAX, and a scanner, and an expansion program execution platform 402, which is an expansion program execution platform, run on an OS 400. Furthermore, a firmware update service 403, an option activate service 404, and a setting management service 405 run on the native program 401. Furthermore, an expansion program system service 406 and an expansion program 407 run on the expansion program execution platform 402.

The firmware update service 403 is a service which provides various functions for updating firmware. For example, the firmware update service 403 refers to firmware specified by a user, and determines whether or not the firmware should be updated. The firmware update service 403 also updates firmware with respect to or via the native program 401.

The option activate service 404 is a service for activating an option function which is incorporated in advance in the native program 401. The option activate service 404 identifies an option function which is identified by an option license file specified by a user, and activates the option function.

The setting management service 405 is a service for managing various types of setting information of the printer 216, the scanner 217, and the like. The setting management service 405 provides a function for rewriting setting information of the native program 401, for example, when one or more settings or a file including multiple pieces of setting information is specified by a user. The setting management service 405 includes a user interface (hereinafter, referred to as a UI), and a user is able to issue an instruction for changing settings via the operation unit 208 of the MFP 105. Furthermore, the setting management service 405 creates a file of setting information and provides the file, in response to a request from an expansion program transmitted through the expansion program system service 406. This function will be referred to as export of a device setting information file.

The expansion program system service 406 is a utility library which is useful in common among expansion programs, and is provided from the system. By calling a function of the expansion program system service 406 from the expansion program 407, time and effort for developing an expansion program may be reduced. The expansion program 407 is able to access, only via the expansion program execution platform 402 or the expansion program system service 406, a different expansion program 407 and each module of the MFP 105, such as the RAM 202. Furthermore, the expansion program 407 which includes a UI is able to display an icon on a main menu screen displayed on the operation unit 208 of the MFP 105. When the operation unit I/F 203 detects through the operation unit 208 that a user has selected the icon, the operation unit I/F 203 transmits information on the detection to the CPU 201. The CPU 201 receives the information on the detection, and displays the UI of the expansion program selected by the user on the operation unit 208.

Only a basic part of the software configuration has been described. Other services may be included in the software configuration under some execution environments. Furthermore, for a reason such as limiting settings, unnecessary services may not be provided.

### <Software Configuration of Automatic Installation Program>

FIG. 4B illustrates an example of a functional configuration of an automatic installation program 450 that runs on the MFP 105. In the first embodiment, the automatic installation program 450 is implemented as one of the expansion programs 407 of the MFP 105. When the CPU 201 executes a program corresponding to each function, the function is implemented.

Referring to FIG. 4B, the automatic installation program 450 includes a UI controller 451, a processing execution unit 452, a script analysis unit 453, an operation state analysis unit 454, and a communication unit 455. The UI controller 451 provides a UI for operating the automatic installation program 450 to a user through the operation unit 208, and receives an operation by the user.

The processing execution unit 452 performs various setting processes in accordance with an instruction by the UI controller 451 and an analysis result by the script analysis unit 453. The script analysis unit 453 analyzes an installation script (case information), which is installation operation instruction information, and determines the process and order to be executed by the processing execution unit 452.

The operation state analysis unit 454 analyzes and classifies operation state data of an installation operation. The operation state data will be described later. The communication unit 455 transmits data to the case management server 107 and acquires data, in accordance with an instruction by the processing execution unit 452. Furthermore, the communication unit 455 acquires various types of software such as firmware and a license file from the software management server 108, in accordance with an instruction by the processing execution unit 452.

### <Software Configuration of Case Creation Program>

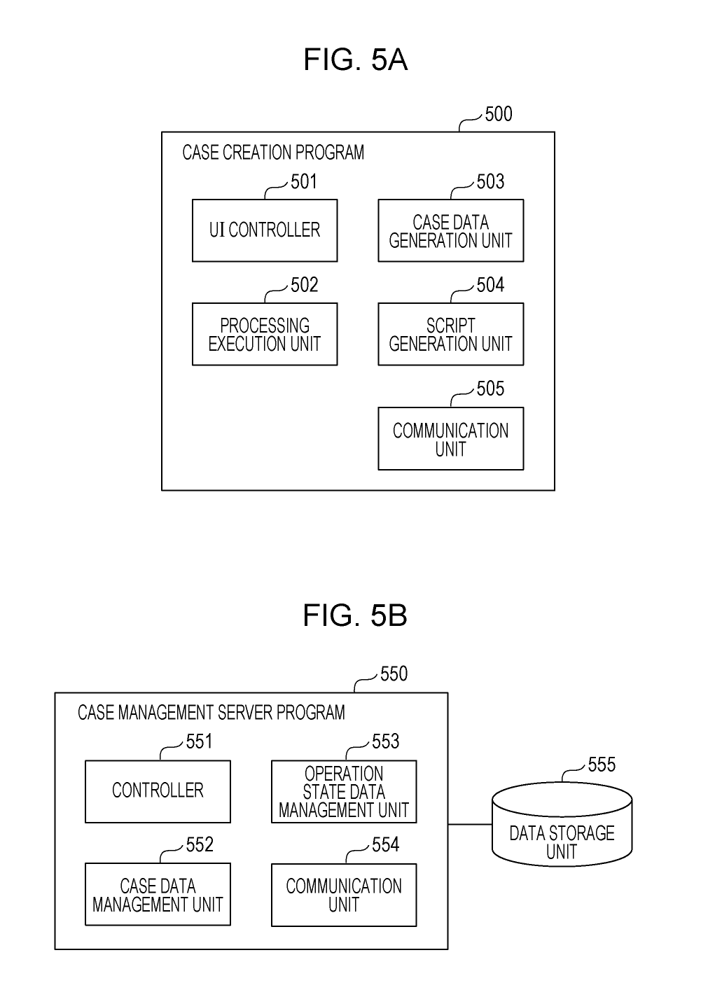

FIGS. 5A and SB are diagrams for explaining software configurations of the client computer 106 and the case management server 107 illustrated in FIG. 1. In particular, FIG. 5A illustrates an example of a functional configuration of a case creation program 500 which runs on the client computer 106.

Referring to FIG. 5A, when the CPU 251 executes a program, each function is implemented. Although in the first embodiment it is assumed that a program is executed at the client computer 106, the present invention is not limited to this. A program may be executed at a server or a service on a network through the network I/F 258.

The case creation program 500 includes a UI controller 501, a processing execution unit 502, a case data generation unit 503, a script generation unit 504, and a communication unit 505. The UI controller 501 provides a UI for operating the case creation program 500 to an operator through the display 261, and receives an operation by the operator through the mouse 259 and the keyboard 260. The processing execution unit 502 performs various processes in accordance with an instruction by the UI controller 501. The case data generation unit 503 generates case data in accordance with an instruction by the processing execution unit 502, based on input information from the UI controller 501. The script generation unit 504 generates an installation script which may be analyzed by the automatic installation program 450, based on the case data generated by the case data generation unit 503, in accordance with an instruction by the processing execution unit 502. The communication unit 505 transmits case data to the case management server 107 and acquires case data held at the case management server 107, in accordance with an instruction by the processing execution unit 502.

### <Software Configuration of Case Management Server Program>

FIG. 5B illustrates an example of the functional configurations of a case management server program 550 which runs on the case management server 107 and a data storage unit 555.

Referring to FIG. 5B, when the CPU 301 executes a program, each function is implemented. The case management server program 550 is a Web application which includes a controller 551, a case data management unit 552, an operation state data management unit 553, and a communication unit 554. The controller 551 instructs the case data management unit 552 and the operation state data management unit 553, for example, to store, delete, update, or acquire case data and operation state data, in accordance with request details received at the communication unit 554. The case data management unit 552 stores, deletes, or updates case data for the data storage unit 555, which will be described later, in accordance with an instruction by the controller 551.

For example, the case data management unit 552 also acquires case data from the data storage unit 555. The operation state data management unit 553 stores, deletes, and updates operation state data for the data storage unit 555, in accordance with an instruction by the controller 551. For example, the operation state data management unit 553 also acquires operation state data from the data storage unit 555.

The communication unit 554 receives a request from the client computer 106 or the like, and transmits request details to the controller 551. The communication unit 554 also receives a processing result regarding a request from the controller 551, creates response data to the request, and transmits a response to the client computer 106 or the like.

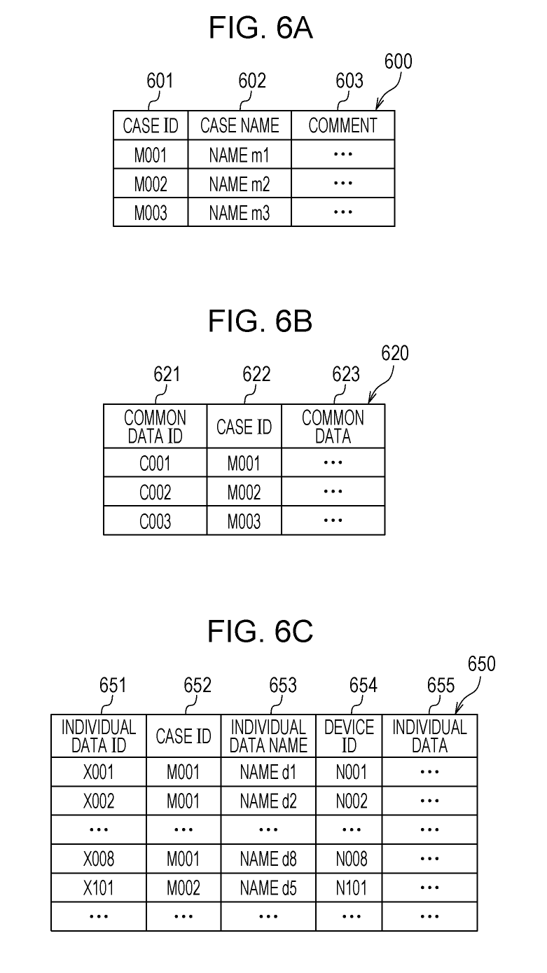

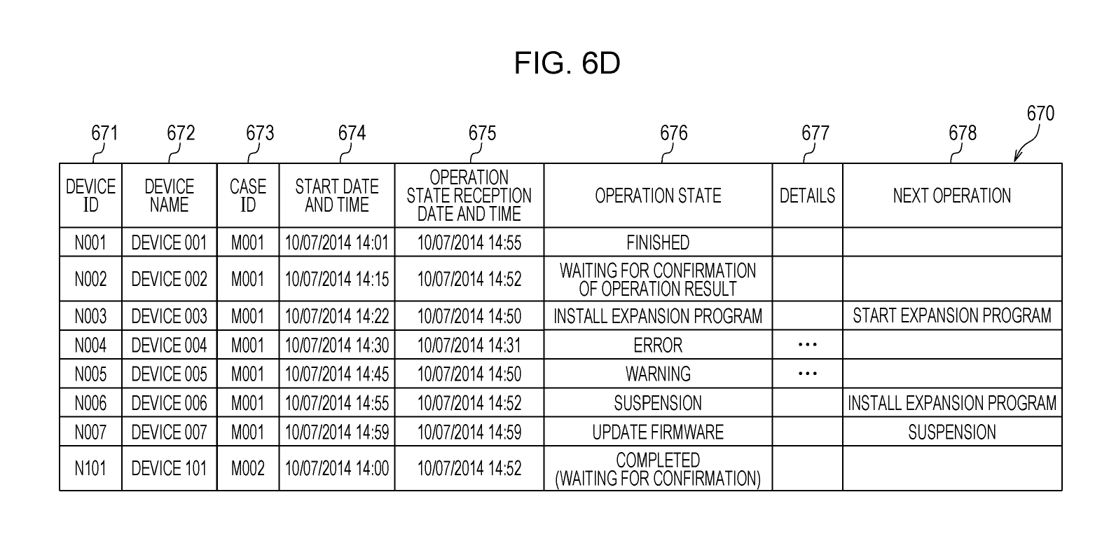

The data storage unit 555 is a database which runs on the case management server 107. When the CPU 301 executes a program, each function is implemented. Although in this example, the data storage unit 555 is provided at the case management server 107, the data storage unit 555 may be arranged in a different server as long as it can cooperate with the case management server program 550. The details of data managed at the data storage unit 555 will be explained later with reference to FIGS. 6A to 6D.

### <Table Group Managed at Data Storage Unit>

FIGS. 6A to 6D are diagrams illustrating examples of tables which are managed by the data storage unit 555 illustrated in FIG. 5B and a table for managing an operation state. The tables illustrated in FIGS. 6A to 6C represent case data. FIG. 6D represents operation state data. The table configurations illustrated in FIGS. 6A to 6D are merely examples, and table configurations different from the examples are also possible.

FIG. 6A illustrates a case outline management table 600.

Referring to FIG. 6A, the case outline management table 600 is a table which stores outline of cases, and includes columns 601 to 603. A single record represents one case. The column 601 represents a case ID. The case ID is an identifier for uniquely identifying case data. The column 602 represents the name of case data. The column 603 represents a comment. The comment is an auxiliary explanation about the details of a case.

FIG. 6B illustrates a common data management table 620.

Referring to FIG. 6B, the common data management table 620 is a table for managing data which is set for each case in common among installation target MFPs, and includes column 621 to 623. The column 621 represents a common data ID. The common data ID is an identifier for uniquely identifying common data. The column 622 represents a case ID. The column 623 represents common data. In this example, the entity of common data is stored in the column 623. However, only a path to the entity of common data may be stored in the column 623, and the entity of the common data may be placed in a different location as a file. In the column 621 and the column 622, common data and a case are associated with each other. For example, referring to the first record, common data with a common data ID of “C001” is used for a case with a case ID of “M001”.

FIG. 6C illustrates an individual data management table 650.

Referring to FIG. 6C, the individual data management table 650 is a table for managing data which is set for each MFP 105 as an installation target, and includes columns 651 to 655. The column 651 represents an individual data ID. The individual data ID is an identifier for uniquely identifying individual data. The column 652 represents a case ID. The column 653 represents the name of individual data. The column 654 represents a device ID of an MFP as an installation target. The column 655 represents individual data.

In this example, the entity of individual data is stored in the column 655. However, only a path to the entity of individual data may be stored in the column 655, and the entity of the individual data may be placed in a different location as a file. In the columns 651, 652, and 654, individual data, a case, and an MFP are associated with one another.

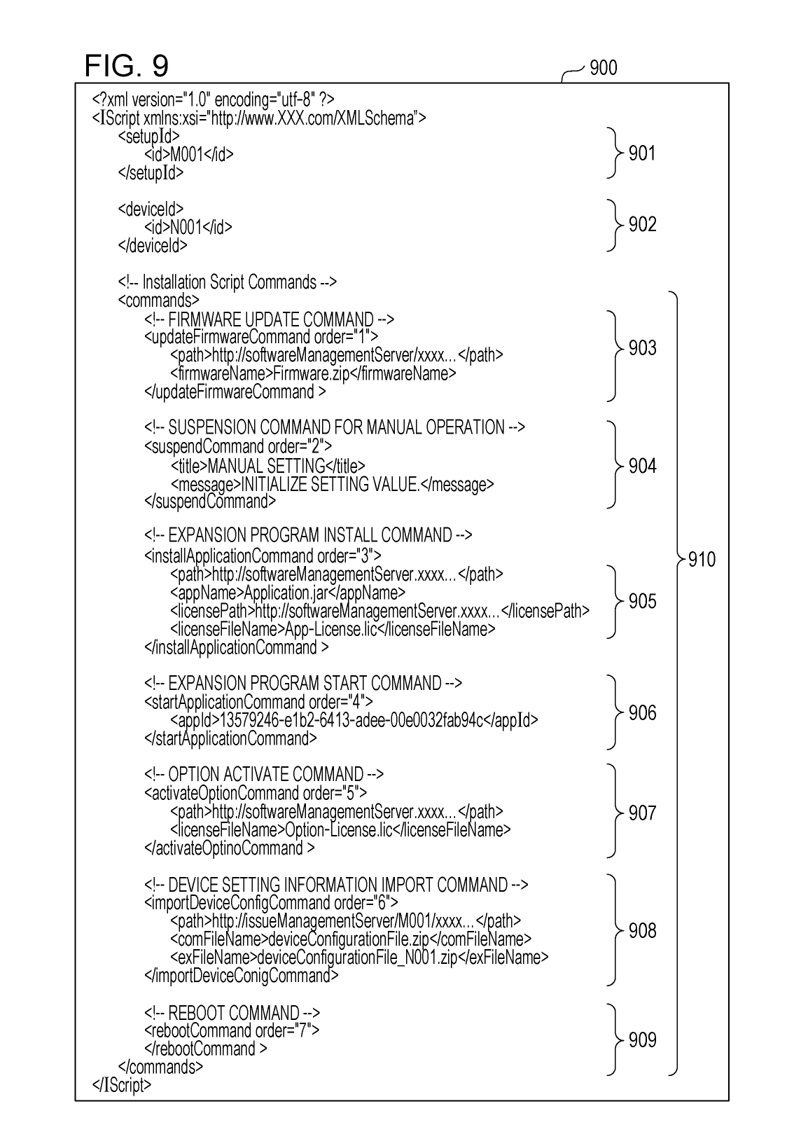

For example, referring to the first record, individual data with an individual data ID of “X001” is data set for the MFP 105 with a device ID of “N001” in a case with a case ID of “M001”. Individual data includes an installation script. A configuration of the installation script will be described later with reference to FIG. 9.

FIG. 6D illustrates an operation state data management table 670.

Referring to FIG. 6D, the operation state data management table 670 is a table for managing an operation state of an automatic installation operation of the MFP 105, and includes columns 671 to 678. The column 671 represents a device ID of the MFP 105. The column 672 represents a device name of the MFP 105. The column 673 represents a case ID.

The column 674 represents the date and time at which an automatic installation operation started. The column 675 represents the date and time at which operation state data was received from the MFP 105. The column 676 represents the operation state of an automatic installation operation for the MFP 105. The column 677 represents detailed information regarding the operation state. The column 678 represents a command to be processed subsequent to the command that is currently being processed. In the columns 671 and 673, a case and an MFP are associated with each other. For example, the first record represents the operation state of an MFP with a device ID of “N001” for a case with a case ID of “M001”.

### <Installation Operation Procedure for MFP>

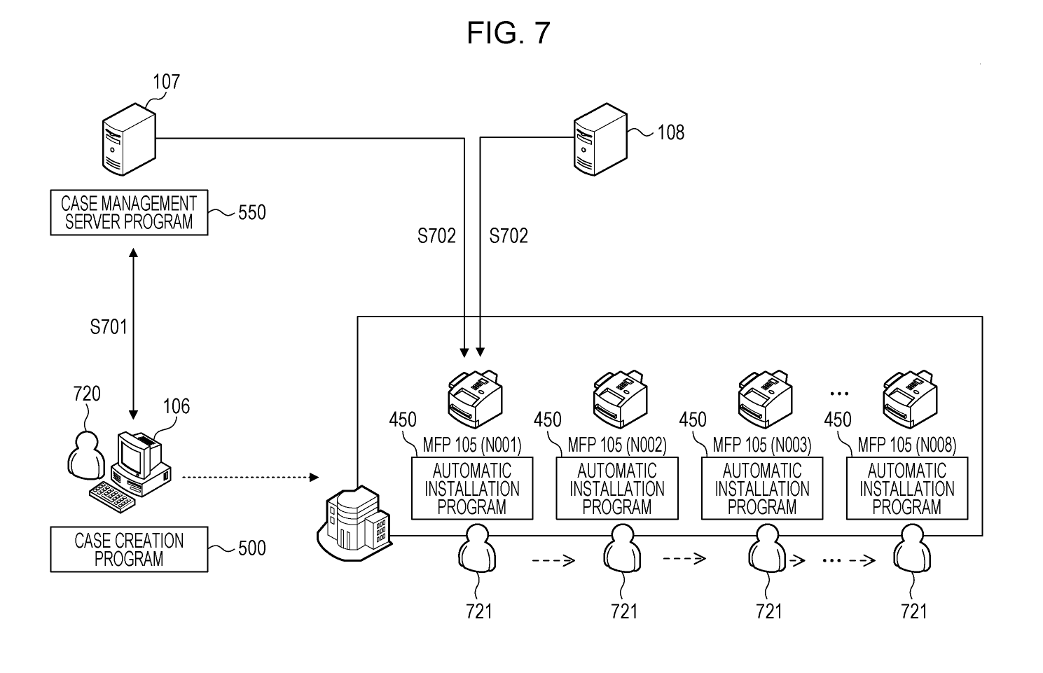

FIG. 7 is a work flow diagram illustrating the flow of a basic operation up to installation of the MFP 105 illustrated in FIG. 1. FIG. 7 illustrates an example in which an installation operation for eight MFPs 105 is performed in a single case.

S701 is an operation in which a case creator 720 operates the client computer 106 to create a case. Creation of a case is not performed by a single person. For the creation of a case, a person in charge of sales talks with a customer and sets determined contents, and an installation administrator slightly corrects the setting contents at a warehouse where warehousing and shipping of the MFPs 105 is managed.

In this example, people who edit a case, such as a person in charge of sales and an installation administrator, are collectively represented by a case creator. The case creator 720 inputs, using the case creation program 500 of the client computer 106, the configuration of the MFPs 105 and the setting details of the MFPs 105. The configuration of the MFP 105 represents a device type, a hardware option, an option to be activated, and an expansion application to be installed. The details of the configuration are transmitted to the case management server 107 as case data, and are stored in the data storage unit 555 of the case management server 107.

S702 is an operation which is performed at a customer site when a person 721 in charge of installation actually installs the MFP 105. When the MFP 105 is delivered from a warehouse, the person 721 in charge of installation arranges the MFP 105 at a location requested by a customer. Then, the person 721 in charge of installation connects the MFP 105 to the LAN 101 at the customer site. In this example, an installation operation is performed after the MFP 105 is connected to the LAN 101 at the customer site. However, the MFP 105 is not necessarily connected to the LAN 101 at the customer site in the installation operation. The MFP 105 only needs to be able to communicate with the case management server 107 and the software management server 108.

For example, the MFP 105 may have a wireless communication function, so that the MFP 105 may communicate with the case management server 107 and the software management server 108 by using a tethering function of a portable terminal or the like owned by the person 721 in charge of installation.

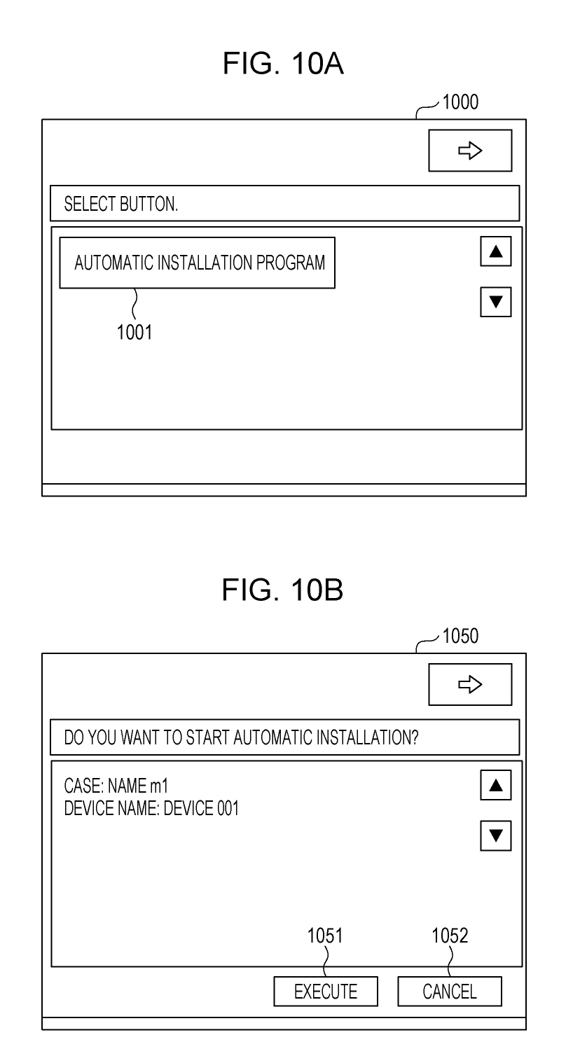

The person 721 in charge of installation presses a button for installation through a UI displayed by the automatic installation program 450 of the MFP 105. The UI displayed here will be described later with reference to FIG. 10B and the like.

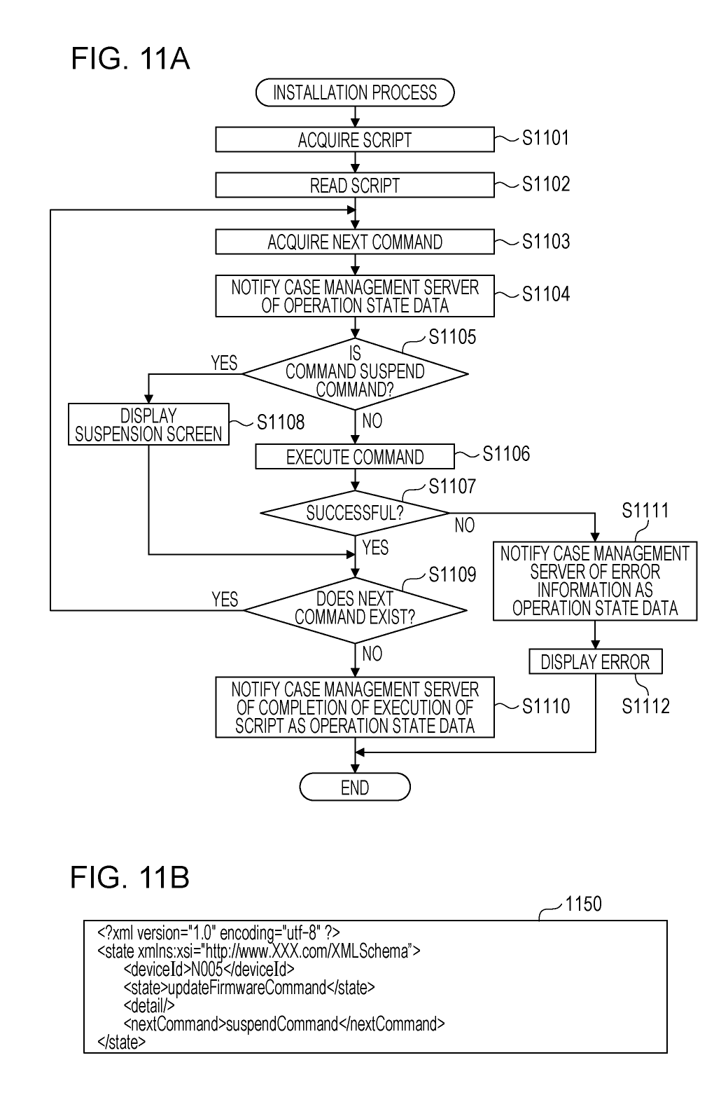

When the automatic installation program 450 detects that a button for installation is pressed through the operation unit 208 of the MFP 105, an installation operation starts automatically. An automatic installation operation process will be described later with reference to FIG. 11A.

When the automatic installation operation starts at the MFP 105, the person 721 in charge of installation moves away from the location of the MFP 105, and moves onto an installation operation for the next MFP 105. Accordingly, by repeating the operation of S702 for the MFPs 105 with device IDs of “N001” to “N008”, installation operations for all the MFPs 105 are completed.

The person 721 in charge of installation does not simply repeat the operation of S702. If there is a need to perform a manual operation for the MFP 105 for which automatic installation is being performed, the person 721 in charge of installation returns to the location of the corresponding MFP 105 to perform a manual operation. In the first embodiment, the person 721 in charge of installation is able to identify the MFP 105 that requires a manual operation, and it is easily determined whether the person 721 in charge of installation should return to the MFP 105 that requires a manual operation or move onto installation of the next MFP 105. Such processing will be described below.

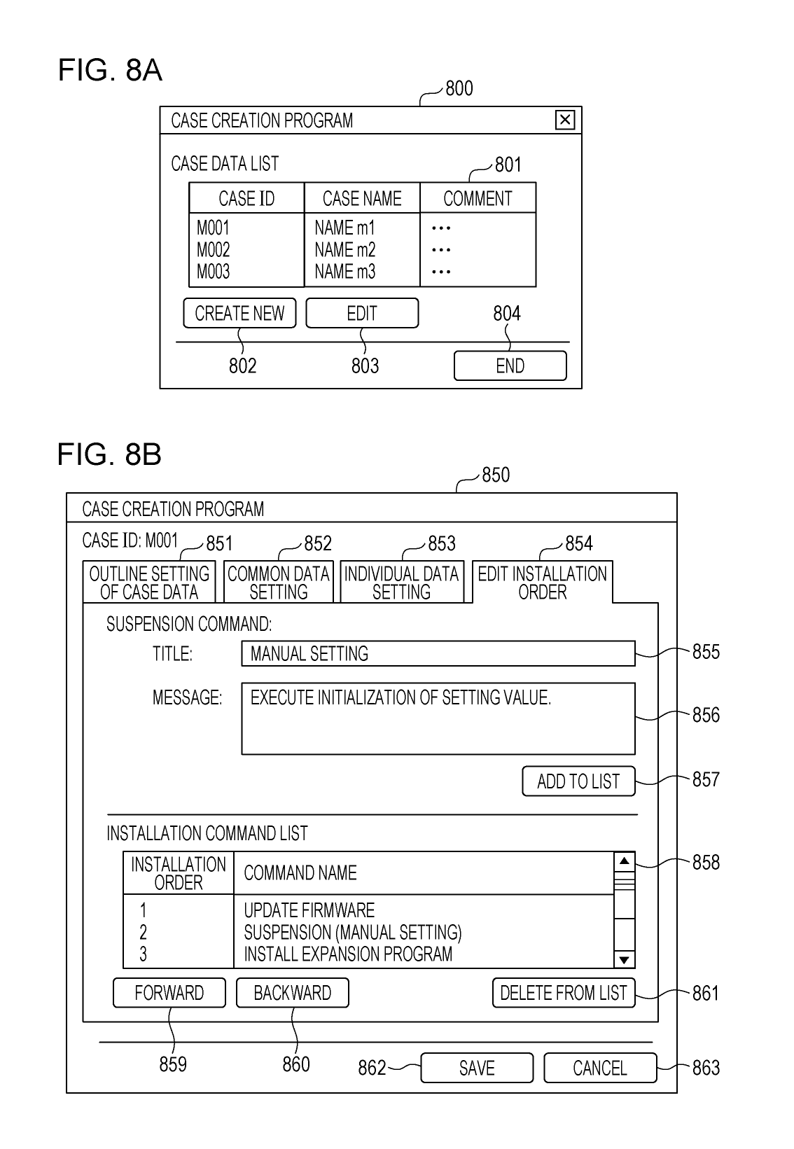

The operation flow up to basic installation of the MFP 105 according to an embodiment of the present invention has been described above. Detailed processing of each program in an operation up to the basic installation which has been explained above with reference to FIG. 7 will be described with reference to FIGS. 8A and 8B, FIG. 9, FIGS. 10A and 10B, FIGS. 11A and 11B, FIG. 12, FIGS. 13A to 13C, FIG. 14, and FIGS. 15A to 15C.

### <Case Creation Program>

FIGS. 8A and 8B are diagrams illustrating examples of a UI screen displayed at the client computer 106 illustrated in FIG. 1. The UI screen in this example is a screen which is provided by the case creation program 500 of the client computer 106 illustrated in FIG. 1. The UI is operated when the case creator 720 performs the operation of S701.

FIG. 8A illustrates an example of a UI which displays a list of case data of the case creation program 500.

Referring to FIG. 8A, a UI 800 includes a case data list 801 and buttons 802 to 804. When the case creation program 500 is activated, the case creation program 500 acquires a list of case data from the case management server 107. Then, the case creation program 500 sets the acquired list of case data to the case data list 801, and displays the UI 800. The case data list 801 is a list which displays information on the case data. In this example, a case ID, a case name, and a comment are displayed as a list.

The button 802 is a button for newly creating case data. When detecting the button 802 is pressed, the case creation program 500 displays a UI 850 (see FIG. 8B) for creating case data, which will be described later.

Pressing of the button 802 means newly creating case data. Therefore, the UI 850 is displayed in a state in which individual controls such as text boxes are empty.

The edit button 803 is a button for editing case data. When detecting that the edit button 803 is pressed, the case creation program 500 acquires detail information of case data which is in a selected state in the case data list 801 from the case management server 107.

The case creation program 500 sets the acquired detail information of the case data for individual controls such as text boxes of the UI 850, and displays the UI 850. The button 804 is a button for ending the case creation program 500.

FIG. 8B illustrates an example of a UI for editing case data of the case creation program 500.

Referring to FIG. 8B, the UI 850 includes tab pages 851, 852, 853, and 854 and buttons 862 and 863. On the UI 850, the tab page 854 is displayed in an active state.

The tab page 854 includes a text box 855 to a button 861 including text boxes and buttons. As the UI 850, an example in which a case with a case ID of “M001” is being edited is described. That is, when the edit button 803 is pressed on the UI 800 in the state in which “M001” is selected as a case ID, the UI 850 is displayed.

The tab page 851 is a tab page for setting the outline of case data. The outline of case data represents a case name, a comment, and the like. The tab page 852 is a tab page for performing setting of common data. The common data is data which is set for each case in common among installation target MFPs, as described above.

The tab page 853 is a tab page for performing setting of individual data. The individual data is data which is set for each installation target MFP 105, as described above.

For example, the individual data represents setting of a license required for each MFP 105, setting of an installation location, and the like. The tab page 854 is a tab page for setting the execution order of commands for setting common data and individual data set through the tab pages 852 and 853 for the MFP 105.

The tab page 854 includes the text box 855, the button 861, and the like, as described above. Controls for the text box 855 to the button 857 are controls for setting a suspension command. The suspension command is a command for temporarily stopping an automatic installation operation.

When the suspension command is executed through the automatic installation program 450 of the MFP 105, an automatic installation operation is stopped until a reboot instruction through a UI operation is received. The person 721 in charge of installation performs a manual operation while the automatic installation operation is stopped. That is, the case creator 720 sets a suspension command for a location where an operation through manual setting by operation on the UI is required.

The text box 855 is a text box for setting a title which is displayed through the UI of the automatic installation program 450 of the MFP 105 during suspension. The text box 856 is a text box for setting a message which is displayed through the UI of the automatic installation program 450 of the MFP 105 during suspension.

The button 857 is a button for adding a suspension command which is set in the text boxes 855 and 856 to an installation command list 858. The installation command list 858 is a list for displaying a list of commands to be executed in an automatic installation operation. Commands set in a “command name” column are executed in the order set in an “installation order” column.

That is, a command arranged in an upper part in the installation command list 858 is executed earlier. The button 859 is a button for moving the position forward in the execution order of a command in a selected state in the installation command list 858. The button 860 is a button for moving the position backward in the execution order of a command in a selected state in the installation command list 858. The button 861 is a button for deleting a command in a selected state in the installation command list 858 from case data that is being edited.

The button 862 is a button for storing case data that is being edited. When the button 862 is pressed, the case creation program 500 transmits the case data to the case management server 107. Then, when receiving the case data, the case management server program 550 of the case management server 107 stores the received case data into the data storage unit 555. The button 863 is a button for canceling editing of case data.

### <Example of Installation Script>

FIG. 9 is a diagram illustrating an example of an installation script in which an installation operation procedure for automatically executing installation of the MFP 105 is described. The installation script is stored in the data storage unit 555 of the case management server 107 as a part of case data created through the UI 850.

Referring to FIG. 9, an installation script 900 is analyzed by the script analysis unit 453 through the processing execution unit 452 of the automatic installation program 450 of the MFP 105. With the installation script 900 which has been analyzed by the script analysis unit 453, a process described by the processing execution unit 452 is then executed.

The installation script 900 is described using (Extensible Markup Language (XML), and includes a case data identification part 901, an MFP identification part 902, and a command description part 910. Although a script is expressed using the XML in FIG. 9, the script is not necessarily expressed using the XML. The installation script 900 may be described as a shell script or the like.

In the case data identification unit 901, a case ID for identifying case data is described, and includes a <setupId> tag. The case ID is an identifier which is a provided for case data when the case data is generated by the case creation program 500, and is a value unique to each case data. In this example, for easier explanation, a four-digit character string such as “M001” is described. However, it is desirable that, for example, a global unique identifier (GUID) or the like is used.

In the MFP identification part 902, a target identifier for identifying the MFP 105 is described, and includes a <deviceId> tag.

In the command description part 910, a command group necessary for installation is described. The command description part 910 includes a firmware update command part 903, a suspension command part 904, an expansion program install command part 905, an expansion program start command part 906, and an option activate command part 907. The command description part 910 also includes a device setting information import command part 908 and a reboot command part 909. A tag indicating each command includes an Order attribute. In FIG. 9, the processing order is determined according to the Order value.

The firmware update command part 903 is a command for updating firmware through the firmware update service 403. The firmware update command part 903 defines the command by describing an <updateFirmwareCommand> tag, and specifies a file to be used by a <path> tag and a <firmwareName> tag. The <path> tag describes a path up to firmware of the software management server 108 to be updated. The <firmwareName> tag specifies firmware to be updated. In FIG. 9, the firmware archived in a Zip format is specified.

The suspension command part 904 is a command for suspending an automatic installation operation, and defines the command by describing a <suspendCommand> tag. A <title> tag indicates a title displayed through the UI of the automatic installation program 450 of the MFP 105 during suspension. As the value of the <title> tag, a character string set in the text box 855 on the UI 850 of the case creation program 500 is set. A <message> tag indicates a message displayed through the UI of the automatic installation program 450 of the MFP 105 during suspension. As the value of the <message tag>, a character string set in the text box 856 on the UI 850 of the case creation program 500 is set.

The expansion program install command part 905 is a command for installing an expansion program. The expansion program install command part 905 defines the command by describing an <installApplicationCommand> tag, and specifies an expansion program to be installed by a <path> tag and an <appName> tag. The <path> tag describes a path up to the entity of an expansion program as an installation target of the software management server 108.

The <appName> tag specifies the entity of an expansion program to be installed. In FIG. 9, an expansion program in a Jar file format is specified. The format of the expansion program is not limited to the Jar file format. Furthermore, a license for the expansion program as the installation target is specified by a <licensePath> tag and a <licenseFileName> tag. The <licensePath> tag describes a path up to a license file of an expansion program of the software management server 108. The <licenseFileName> tag specifies the entity of a license of an expansion program. In FIG. 9, a license file in a lic file format is specified. The file format of a license is not limited to this.

The expansion program start command part 906 is a command for starting an expansion program. The expansion program start command part 906 defines the command by describing a <startApplicationCommand> tag, and specifies an expansion program to be started by an <appId> tag. The <appId> tag specifies an ID for uniquely identifying an expansion program to be started.

The option activate command part 907 is a command for activating an option function through the option activate service 404. The option activate command part 907 defines a command by describing an <activateOptionCommand> tag. Furthermore, the option activate command part 907 specifies a license file of an option to be activated by a <path> tag and a <licenseFileName> tag. The <path> tag describes a path up to a license file of an option to be activated by the software management server 108.

In FIG. 9, a license file in the lic format is specified. However, the file format of a license is not limited to this. If there is no option function which is incorporated within the MFP 105 in advance or no option function is to be activated, description of this processing is unnecessary.

The device setting information import command part 908 is a command for importing setting information of a device through the setting management service 405. The device setting information import command part 908 defines a command by describing an <importDeviceConfigCommand> tag. Furthermore, the device setting information import command part 908 specifies a device setting information file to be imported by a <path> tag, a <comfileName> tag, and an <exFileName> tag.

The <path> tag describes a path up to a device setting information file to be imported through the case management server 107. The <comfileName> tag specifies a file of common data in the device setting information as an import target. In FIG. 9, a file of common data which is archived in the Zip format is specified. The format of the device setting information file is not limited to the Zip file format. The <exFileName> tag specifies a file of individual data in device setting information as an import target.

The reboot command part 909 includes only a <rebootCommand> tag, and is processing for, after a series of installation processing is finished, rebooting the MFP 105 and causing settings of device setting information and application setting information to be reflected in the MFP.

Description of the installation script illustrated in FIG. 9 does not limit processing necessary for installation of the MFP 105. There may be redundant processing and increase or decrease of the number of processing operations as needed.

### <Automatic Installation Processing by Automatic Installation Program>

FIGS. 10A and 10B are diagrams illustrating examples of a UI displayed on the operation unit 208 of the MFP 105. The UI is operated when the person 721 in charge of installation performs the operation of S702.

FIG. 10A illustrates an example of a UI of the native program 401 of the MFP 105.

Referring to FIG. 10A, a UI 1000 includes a button 1001. The button 1001 is a button for activating the automatic installation program 450. When detecting that the button 1001 is pressed, the native program 401 activates the automatic installation program 450. In the first embodiment, for easier explanation, only the button 1001 is illustrated. However, the present invention is not limited to this.

That is, a button for displaying a UI for setting printing and FAX to be executed by the native program 401 and a button for activating a different expansion program 407 may be displayed.

FIG. 10B illustrates an example of a UI of the automatic installation program 450 illustrated in FIG. 4B. The UI is displayed when the button 1001 of the UI 1000 is pressed.

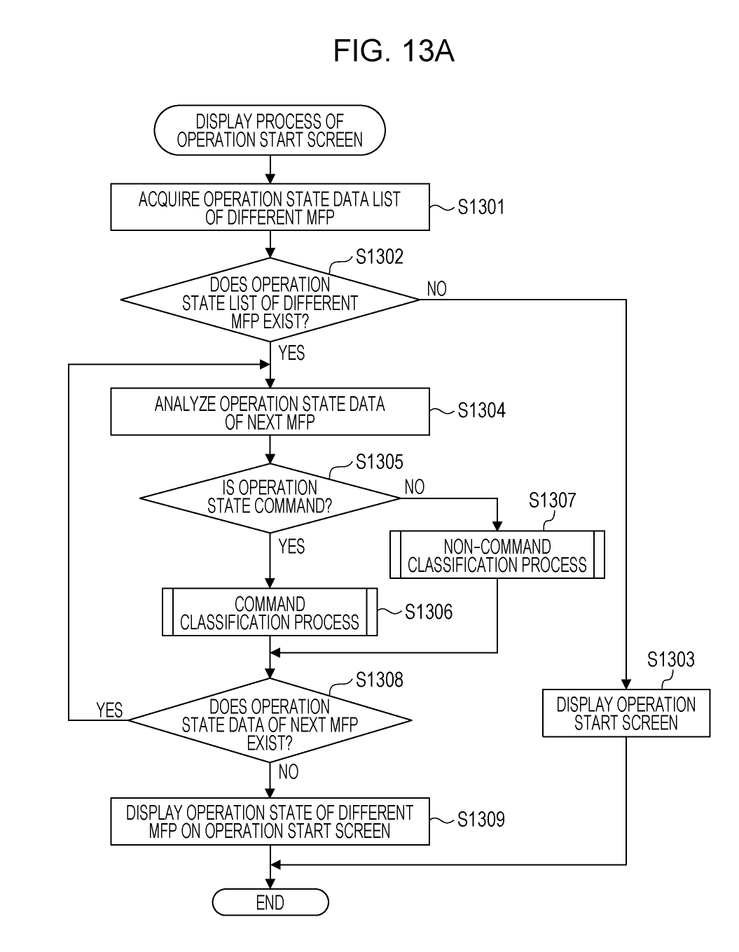

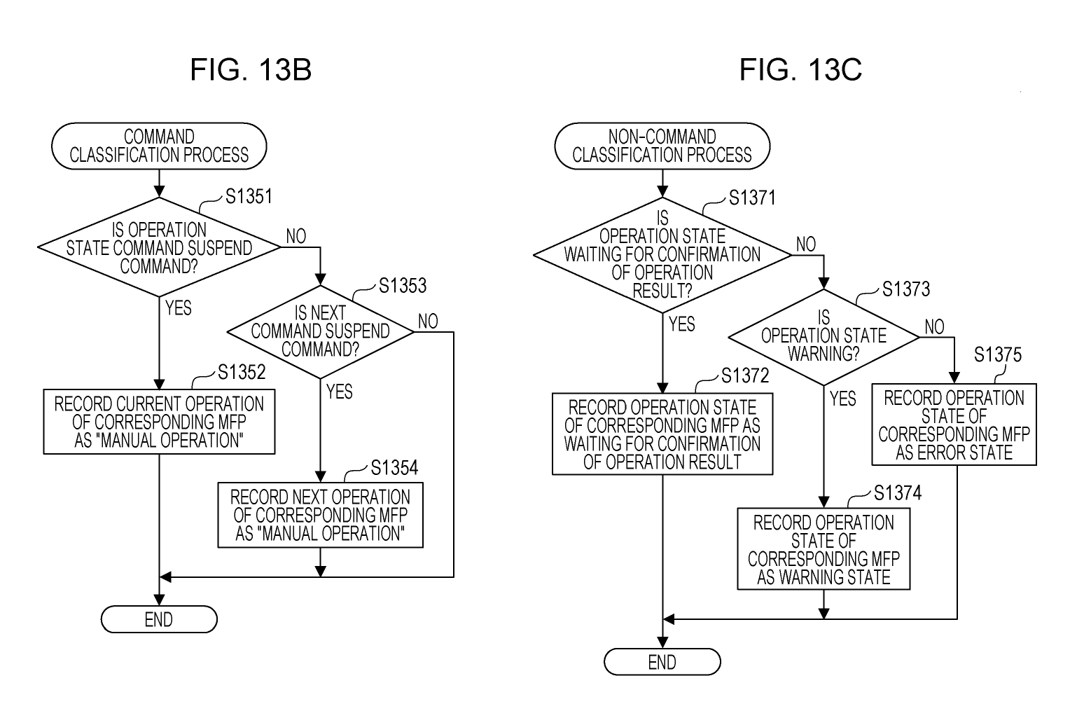

Processing for displaying the UI of the automatic installation program 450 after the button 1001 is pressed will be described later with reference to FIGS. 13A to 13C.

Referring to FIG. 10B, a UI 1050 includes a button 1051 and a button 1052. The UI is, in particular, displayed by the automatic installation program 450 of the MFP 105 with a device ID of “N001”. That is, the MFP 105 is the MFP that is set by the person 721 in charge of installation at first in S702.

The button 1051 is a button for executing an automatic installation operation. When detecting that the button 1051 is pressed, the automatic installation program 450 starts an automatic installation operation. Processing of the automatic installation operation will be explained with reference to FIGS. 11A and 11B.

The button 1052 is a button for ending the automatic installation program 450.

FIGS. 11A and 11B are diagrams for explaining a process of an automatic installation operation performed by the automatic installation program 450. FIG. 11A is a flowchart illustrating an example of a process of an automatic installation operation performed by the automatic installation program 450. FIG. 11B is a diagram illustrating an example of operation state data transmitted to the case management server 107. Individual steps are implemented when the CPU 201 executes the stored automatic installation program 450. Hereinafter, modules illustrated in FIGS. 4A and 4B will be mainly explained.

In S1101, the communication unit 455 of the automatic installation program 450 acquires an installation script from the case management server 107, and the process proceeds to S1102. More specifically, the communication unit 455 of the automatic installation program 450 issues a request using a GET command of HTTP to the communication unit 554 of the case management server program 550. Here, the request includes the device ID of the MFP 105.

The case data management unit 552 of the case management server program 550 acquires an installation script which corresponds to the device ID included in the request from the individual data management table 650. The communication unit 554 of the case management server program 550 transmits the installation script, which is acquired as a response to the GET command of HTTP, to the communication unit 455 of the automatic installation program 450.

In response to reception of the request for the installation script, the case management server program 550 determines that the MFP 105 has started an automatic installation operation. Therefore, when receiving the request for the installation script, the operation state data management unit 553 of the case management server program 550 newly creates a record of the MFP with the device ID included in the request for the operation state data management table 670. At this time, the columns 671 to 674 are updated.

In S1102, the processing execution unit 452 of the automatic installation program 450 reads the installation script acquired in S1101, and the process proceeds to S1103. In S1103, the script analysis unit 453 of the automatic installation program 450 analyzes the installation script to acquire the next command to be processed, and the process proceeds to S1104.

In the example of the installation script 900 illustrated in FIG. 9, the script analysis unit 453 of the automatic installation program 450 acquires the command parts 903 to 909 in order, which are described in the command description part 910 of the script analysis unit 453. That is, at first, the firmware update command part 903 is acquired.

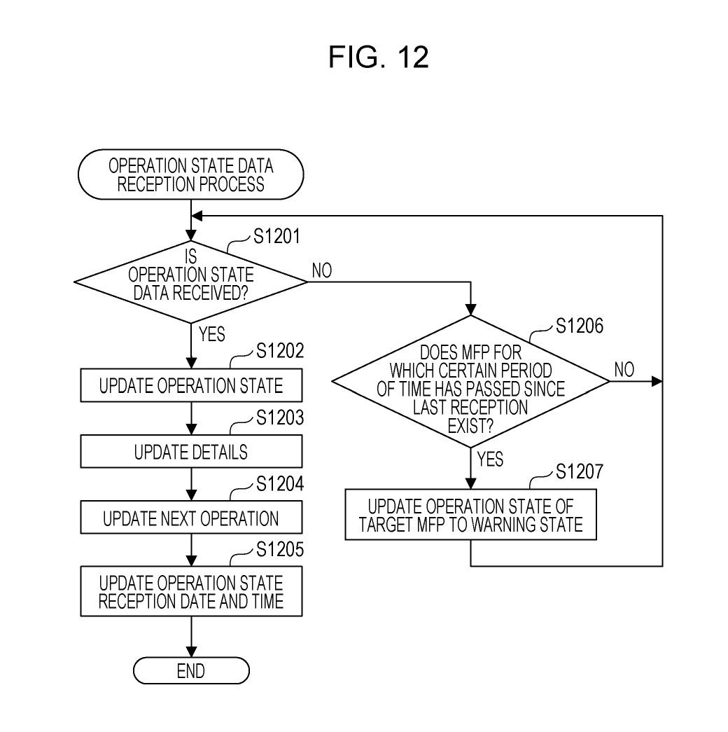

In S1104, the communication unit 455 of the automatic installation program 450 transmits the current operation state data to the case management server 107, in response to an instruction from the processing execution unit 452, and the process proceeds to S1105. Processing of the case management server program 550 of the case management server 107 for the case where the operation state data is received, will be explained later with reference to FIG. 12.

An example of operation state data transmitted to the case management server 107 will be explained with reference to FIG. 11B. Although the operation state data is expressed using XML in FIG. 11B, the operation state data is not necessarily expressed using XML.

Referring to FIG. 11B, operation state data 1150 represents the operation state of an automatic installation operation by using a <state> tag. A <deviceId> tag specifies the device ID of an MFP, and indicates the MFP whose operation state is represented. A <detail> tag indicates detail information of an operation state, and is described when detail information is necessary according to the operation state. A <nextCommand> tag represents the next command to be executed subsequent to the command that is currently being operated. The above information is transmitted to the case management server program 550 of the case management server 107. Explanation of subsequent steps will be provided by referring back to FIG. 11A.

In S1105, the processing execution unit 452 of the automatic installation program 450 determines whether or not a command to be processed is a suspendCommand, which is a suspension command. When the processing execution unit 452 determines that the command to be processed is a suspendCommand, the process proceeds to S1108. When the processing execution unit 452 determines that the command to be processed is not a suspendCommand, the process proceeds to S1106.

In S1106, the processing execution unit 452 of the automatic installation program 450 performs processing described in the command, and the process proceeds to S1107.

In S1107, the processing execution unit 452 of the automatic installation program 450 determines whether or not the processing of the command performed in S1106 has been successful. When the processing of the command has been successful, the process proceeds to S1109. When an error has occurred in the processing of the command, the process proceeds to S1111.

In S1108, the UI controller 451 of the automatic installation program 450 displays a suspension screen. When the UI controller 451 detects an instruction for reboot of an automatic installation operation through an operation by the person 721 in charge of installation on the suspension screen, the process proceeds to S1109. The person 721 in charge of installation performs a manual operation while the automatic installation operation is suspended.

In S1109, the script analysis unit 453 of the automatic installation program 450 determines whether or not the next command exists. When the script analysis unit 453 determines that the next command exists, the process proceeds to S1103. When the script analysis unit 453 determines that the next command does not exist, the process proceeds to S1110.

In S1110, the communication unit 455 of the automatic installation program 450 transmits the operation state data to the case management server 107, in accordance with an installation by the processing execution unit 452, and the process ends. In the operation state data transmitted in S1110, in the example of the operation state data 1150, not a command but “installationComplete” is described as the value of the <state> tag.

Accordingly, the case management server program 550 is notified of completion of the automatic installation operation. When the processing of S1110 ends, the automatic installation operation at the automatic installation program 450 is completed. However, as described above, the person 721 in charge of installation still needs to perform a manual installation operation for printing and confirming an operation result. Therefore, the person 721 in charge of installation needs to return to the location of the MFP 105.

In S1111, the communication unit 455 of the automatic installation program 450 transmits the operation state data to the case management server 107, in accordance with an instruction by the processing execution unit 452, and the process proceeds to S1112. The operation state data transmitted in S1111 is, in the example of the operation state data 1150, not a command but “Error” is described as the value of the <state> tag. Furthermore, the details of an error are described as the value of the <detail> tag. Accordingly, the case management server program 550 is notified of the occurrence of error in the automatic installation operation.

In S1112, the UI controller 451 of the automatic installation program 450 displays an error screen, and the process ends.

### <Process by Case Management Server Program>

FIG. 12 is a flowchart for explaining a control method for a management device according to the first embodiment. In this example, the control method corresponds to a processing procedure performed when the case management server program 550 of the case management server 107 illustrated in FIG. 1 receives an operation state. Individual steps are implemented when the CPU 301 executes the stored case management server program 550. Hereinafter, the modules illustrated in FIGS. 5A and SB will be mainly explained.

In S1201, the communication unit 554 of the case management server program 550 monitors whether or not operation state data has been received from the MFP 105. When the communication unit 554 determines that operation state data has been received, the process proceeds to S1202. When the communication unit 554 determines that no operation state data has been received, the process proceeds to S1206.

In S1202, the operation state data management unit 553 updates the column 676 for the operation state data management table 670 of the data storage unit 555, in accordance with an instruction by the controller 551, and the process proceeds to S1203. For example, when it is determined in S1201 that the operation state data 1150 has been received, the column 676 of the record with a device ID of the “N005” in the operation state data management table 670 is updated to “update firmware”.

In S1203, the operation state data management unit 553 updates the column 677 for the operation state data management table 670 of the data storage unit 555, in accordance with an instruction by the controller 551, and the process proceeds to S1204. For example, when it is determined in S1201 that the operation state data 1150 has been received, the column 677 of the record with a device ID of “N005” in the operation state data management table 670 is updated to a null character since no value is described as the <detail> tag.

In S1204, the operation state data management unit 553 updates the column 678 for the operation state data management table 670 of the data storage unit 555, in accordance with an instruction by the controller 551, and the process proceeds to S1205. For example, when it is determined in S1201 that the operation state data 1150 has been received, the column 678 of the record with a device ID of “N005” in the operation state data management table 670 is updated to “suspension”.

In S1205, the operation state data management unit 553 updates the column 675 to the current date and time for the operation state data management table 670 of the data storage unit 555, in accordance with an instruction by the controller 551, and the process ends. The processing from S1202 to S1205 is performed independently for the sake of explanation. However, the operation state data management unit 553 may perform the processing from S1202 to S1205 collectively.

In S1206, the controller 551 determines whether or not the MFP 105 that has not transmitted operation state data for a certain period of time exists among MFPs 105 for which automatic installation is being performed.

Specifically, the determination is made by comparing the operation state reception date and time stored in the column 675 of the operation state data management table 670 with the current date and time. When the controller 551 determines that the MFP that has not transmitted operation state data for the certain period time exists, the process proceeds to S1207. When the controller 551 determines that no MFP that has not transmitted operation state data for the certain period time exists, reception of operation state data continues to be monitored.

In S1207, the operation state data management unit 553 updates the operation state of the MFP for which it is determined in S1206 that the MFP has not transmitted operation state data for the certain period of time to a warning state, and reception of operation state data continues to be monitored. Specifically, the column 676 is updated to “warning”.

### <Display Process of Operation Start Screen by Automatic Installation Program>

FIGS. 13A to 13C are flowcharts illustrating a control method of an information processing device according to the first embodiment. In this example, the control method corresponds to a processing example up to the time when the automatic installation program 450 illustrated in FIGS. 4A and 4B displays a screen for accepting start of an automatic installation operation. When detecting that the button 1001 of the UI 1000 is pressed, the native program 401 activates the automatic installation program 450. The activated automatic installation program performs a process described in FIG. 13A. Individual steps are implemented when the CPU 201 executes the stored automatic installation program 450. The modules illustrated in FIGS. 4A and 4B will be mainly explained below.

In S1301, the communication unit 455 of the automatic installation program 450 acquires an operation state data list of a different MFP, which will be described later, from the case management server 107, and the process proceeds to S1302. More specifically, the communication unit 455 of the automatic installation program 450 issues a request using a GET command of HTTP to the communication unit 554 of the case management server program 550. The request includes the device ID of the MFP 105.

The operation state data management unit 553 of the case management server program 550 acquires from the operation state data management table 670 operation state data of an MFP with the same case as the device ID included in the request. The communication unit 554 of the case management server program 550 transmits an operation state data list of a different MFP, which is acquired as a response to the GET command of HTTP, to the communication unit 455 of the automatic installation program 450. For example, when the device ID included in the request is “N008”, the operation state data of the MFP 105 for the case with a case ID of “M001” is acquired. Therefore, the operation state data management unit 553 acquires the operation state data of the MFP 105 with a case ID of “M001” from the operation state data management table 670. However, operation state data indicating “finished” is not acquired. This is because for the MFP 105 whose operation state is “finished”, the person 721 in charge of installation has completed confirmation of an operation result.

Effects achieved by the above processing will be described later. That is, in the state of the operation state data management table 670 illustrated in FIG. 6D, the acquired operation state data list of the MFP 105 includes operation state data with a device ID of “N002” and “N007”.

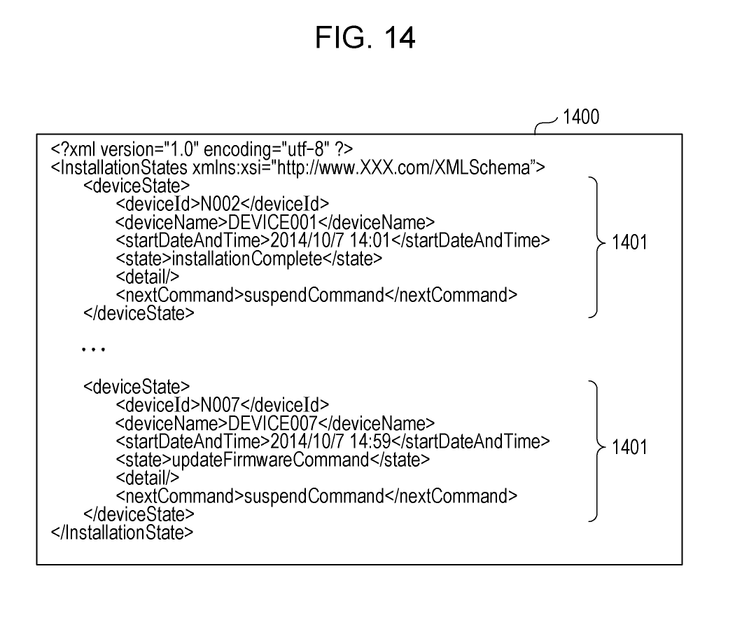

An example of the operation state data acquired in S1301 will be explained with reference to FIG. 14.

Referring to FIG. 14, an operation state data list 1400 is defined by describing an <InstallationStates> tag, and includes multiple operation state data parts 1401.

The operation state data part 1401 is operation state data of a single MFP, and is defined using a <deviceState> tag. A <deviceId> tag represents the device ID of the MFP 105. A <deviceName> tag represents the device name of the MFP 105.

A <startDateAndTime> tag represents the start date and time of an automatic installation operation. A <state> tag represents the operation state. A <detail> tag represents the details of an operation state. A <nextCommand> tag represents the next command to be processed subsequent to the command that is currently being processed. As described above, information described in the operation state data part 1401 is information which is managed by the operation state data management table 670. Explanation of subsequent steps will be provided by referring back to FIG. 13A.

In S1302, the processing execution unit 452 determines whether or not the operation state data list received in S1301 includes operation state data. When no operation state data is included, the process proceeds to S1303. When operation state data is included, the process proceeds to S1304. The case where no operation state data is included may be a case where an installation operation for the first MFP in a case is performed or a case where an installation operation of a different MFP 105 for the same case is completed. In S1303, the UI controller 451 displays an operation start screen, and the process ends. The operation start screen displayed in S1303 corresponds to the UI 1050 explained in FIG. 10B.

In S1304, the operation state analysis unit 454 analyzes the next operation state data in the operation state data list, and the process proceeds to S1305. In the example of the operation state data list 1400, analysis is performed for each operation state data part 1401.

In S1305, the operation state analysis unit 454 determines whether or not the operation state is a command. When the operation state is a command, the process proceeds to S1306. When the operation state is not a command, the process proceeds to S1307. In the example of the operation state data list 1400, the determination is made by determining whether or not the operation state described in the <state> tag is a command. In the case of the operation state data with a device ID of “N002” in the operation state data list 1400, the operation state described in the <state> tag is “installationComplete”, which represents completion of automatic installation. In this case, it is determined that the operation state is not a command. In the case of operation state data with a device ID of “N007”, the operation state described in the <state> tag is “updateFirmwareCommand”, which represents an update firmware command. In this case, it is determined that the operation state is a command.

In S1306, the automatic installation program 450 performs classification processing for a command, and the process proceeds to S1308. The command classification processing of S1306 will be described later with reference to FIG. 13B. In S1307, the automatic installation program 450 performs non-command classification processing, and the process proceeds to S1308. The non-command classification processing will be described later with reference to FIG. 13C.

In S1308, the operation state analysis unit 454 determines whether or not the next operation state data exists in the operation state data list. When the next operation state data exists, the process proceeds to S1304. When the next operation state data does not exist, the process proceeds to S1309.

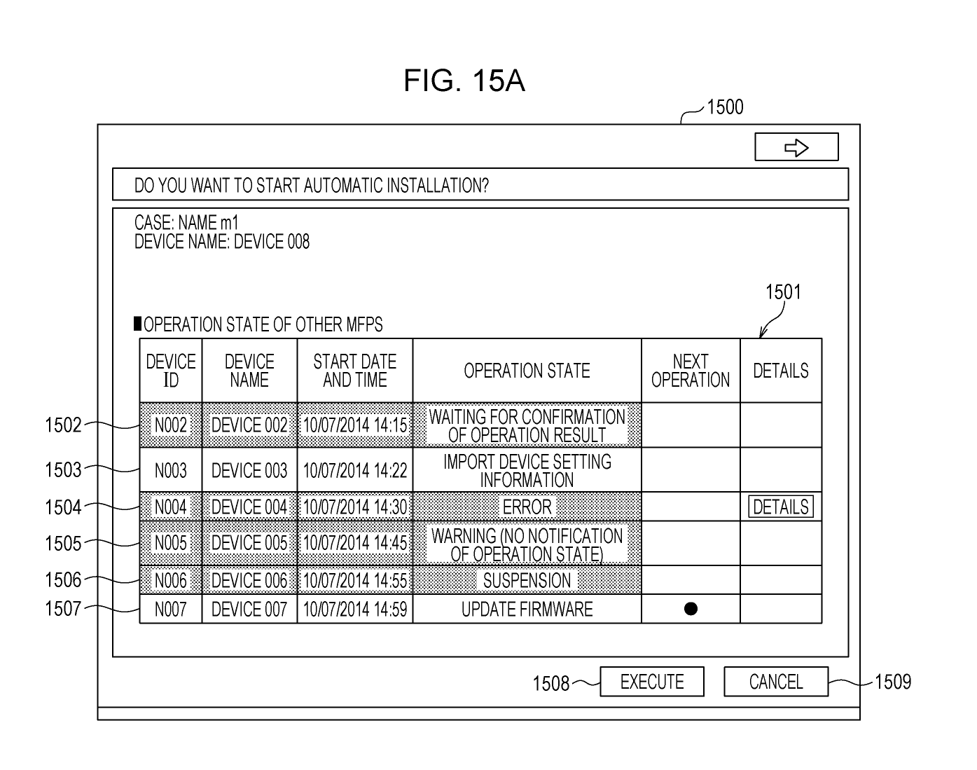

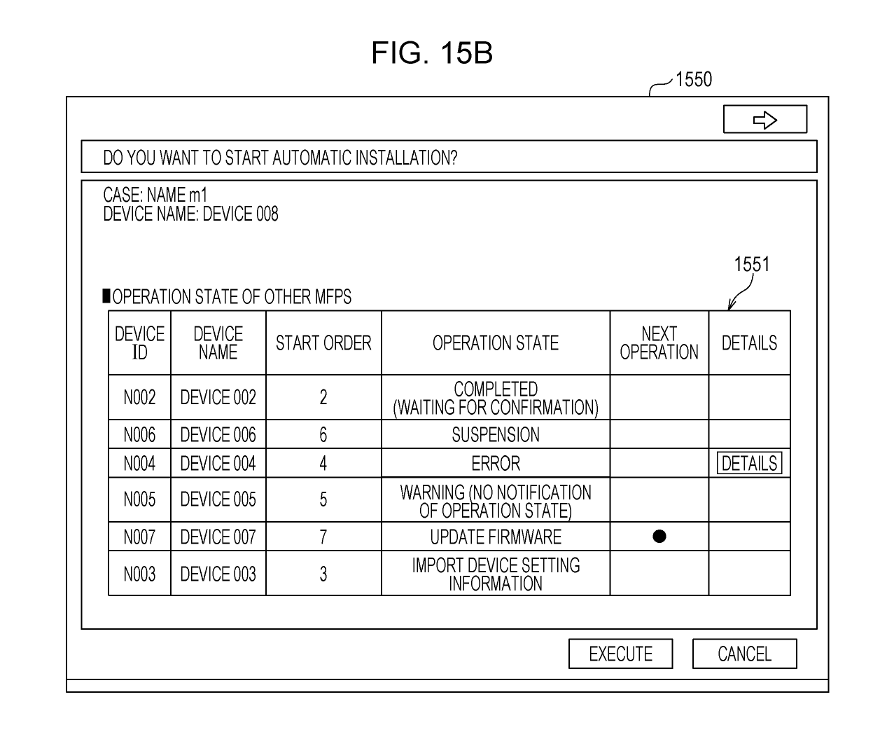

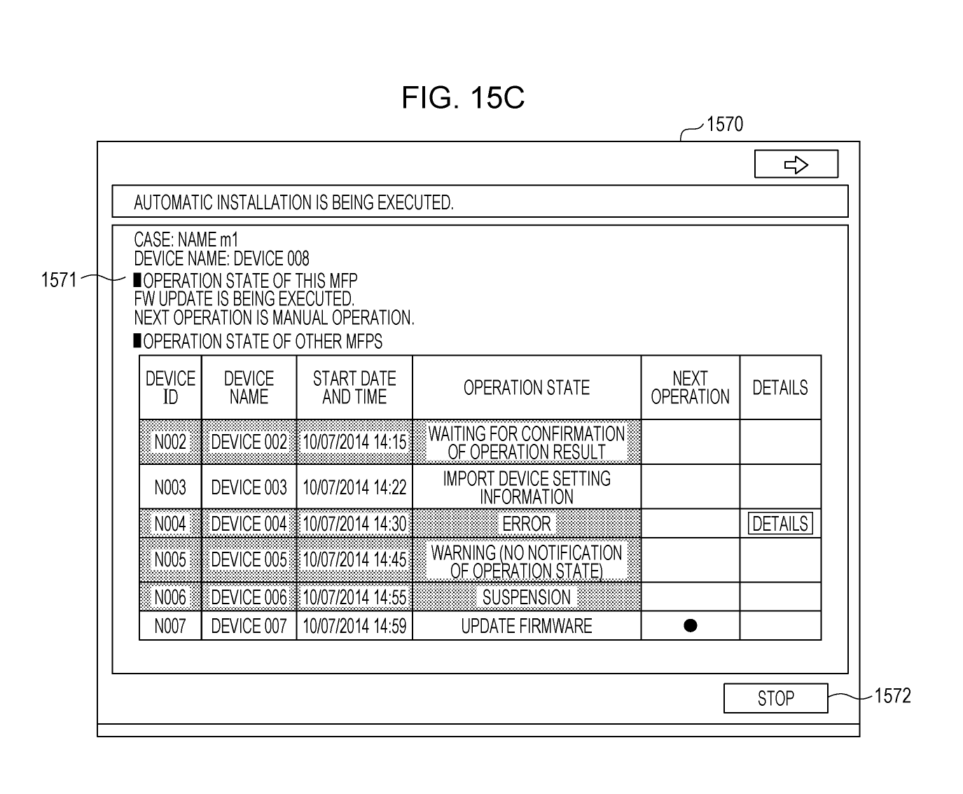

In S1309, the UI controller 451 sets the operation state data of the different MFP in the list, and displays an operation start screen. Then, the process ends. An example of an operation start screen displayed in S1309 will be described later with reference to FIGS. 15A and 15B.

FIG. 13B is a flowchart illustrating a command classification process of the case creation program 500. This is a detailed process of S1306 of FIG. 13A.

In S1351, the operation state analysis unit 454 determines whether or not an operation state command is a suspendCommand, which is a suspension command. When the operation state analysis unit 454 determines that the operation state command is a suspension command, the process proceeds to S1352. When the operation state analysis unit 454 determines that the operation state command is not a suspension command, the process proceeds to S1353.

In S1352, the processing execution unit 452 temporarily records that the current operation of the MFP 105 is a “manual operation”, and the process ends.

In S1353, the operation state analysis unit 454 determines whether or not the next command to be processed subsequent to the command that is currently being processed by the MFP 105 is a suspension command. When the operation state analysis unit 454 determines that the command is a suspension command, the process proceeds to S1354. When the operation state analysis unit 454 determines that the command is not a suspension command, the process ends.

In S1354, the processing execution unit 452 temporarily records that the next operation subsequent to the command that is currently being processed by the MFP 105 is a “manual operation”, and the process ends.

FIG. 13C is a flowchart illustrating a non-command classification process of the case creation program 500. This is a detailed process of S1307 of FIG. 13A.

In S1371, the operation state analysis unit 454 determines whether or not the operation state of the MFP 105 indicates “waiting for confirmation of operation result”, in which an automatic installation process through the automatic installation program is completed. When the operation state analysis unit 454 determines that the operation state of the MFP 105 indicates “waiting for confirmation of operation result”, the process proceeds to S1372. When the operation state analysis unit 454 determines that the operation state of the MFP 105 does not indicate “waiting for confirmation of operation result”, the process proceeds to S1373. In S1372, the processing execution unit 452 temporarily records that the operation state of the MFP 105 indicates “waiting for confirmation of operation result”, and the process ends.

In S1373, the operation state analysis unit 454 determines whether or not the operation state of the MFP 105 is a “warning” state. When the operation state analysis unit 454 determines that the operation state of the MFP 105 is the “warning” state, the process proceeds to S1374. When the operation state analysis unit 454 determines that the operation state of the MFP 105 is not the “warning” state, the process proceeds to S1375.

In S1374, the processing execution unit 452 temporarily records that the operation state of the MFP 105 is the “warning” state, and the process ends. In S1375, the processing execution unit 452 temporarily records that the operation state of the MFP 105 is “error”.

By performing temporary storage according to the above classification, display of the UI described later is switched for each operation state.

FIGS. 15A to 15C are diagrams illustrating examples of a UI screen displayed on an information processing device according to the first embodiment. The UI screen is an example of a UI that the automatic installation program 450 illustrated in FIGS. 4A and 4B displays. FIG. 15A illustrates an example of an operation start screen in which the automatic installation program 450 displays an operation state notified from the case management server 107 in response to a request from an MFP. The UI is displayed by the processing of S1309 explained above with reference to FIG. 13A. In particular, the UI is an example of an operation start screen that the automatic installation program 450 of the MFP 105 with a device ID of “N008” displays in the state of the operation state data management table 670 illustrated in FIG. 6D.

A UI 1500 includes an operation state display list 1501 and buttons 1508 and 1509. In the operation state display list 1501, a single records indicates the operation state of an MFP. The operation state display list 1501 includes columns of “device ID”, “device name”, “start date and time”, “operation state”, “next operation”, and “details”. The “next operation” column indicates in an identifiable manner whether or not the next operation requires a manual operation. When the next operation is a manual operation, a black circle is indicated. In the case where there are many records to be displayed, the operation state display list 1501 provides scroll display.

A record 1502 indicates the operation state of the preceding MFP 105 with a device ID of “N002”. The operation state indicates “waiting for confirmation of operation result”, which is recorded in the processing of S1372. Since the person 721 in charge of installation needs to return to the location of the MFP 105 with a device ID of “N002” to perform a manual operation such as confirmation of an operation result, the color of the record is changed and display is done in an emphasized manner. As described above, by displaying in an emphasized manner the operation state of the MFP 105 which requires a manual operation, the person 721 in charge of installation is able to easily determine whether to move onto an installation operation for the next MFP 105 or move to the location of the MFP 105 that requires a manual operation.

A record 1503 indicates the operation state of the preceding MFP 105 with a device ID of “N003”. A record 1504 indicates the operation state of the MFP 105 with a device ID of “N004”. The operation state indicates “error”, which is recorded in the processing of S1375. In the case of error, the person 721 in charge of installation needs to return to the location of the MFP 105 with a device ID of “N004” to perform a manual operation for error recovery. Therefore, the color of the record is changed and display is done in an emphasized manner.

A record 1505 indicates the operation state of the preceding MFP 105 with a device ID of “N005”. The operation state is “warning”, which is recorded in the processing of S1374. The warning state indicates a state in which operation state data is not transmitted to the case management server 107 from the MFP 105. Since some error may have occurred, the person 721 in charge of installation needs to return to the location of the MFP 105 with a device ID of “N005” to perform confirmation. Therefore, the color of the record is changed and display is done in an emphasized manner.

A record 1506 indicates the operation state of the preceding MFP 105 with a device ID of “N006”. The operation state indicates “suspension”, which is recorded in the processing of S1352 such that the current operation is a “manual operation”. Since the person 721 in charge of installation needs to return to the location of the MFP 105 with a device ID of “N006” to perform a manual operation, the color of the record is changed and display is done in an emphasized manner.

A record 1507 indicates the operation state of the preceding MFP 105 with a device ID of “N007”. The operation state indicates “update firmware”, which requires a manual operation for the next operation. This is recorded in the processing of S1354 such that the next operation subsequent to the operation that is currently being performed is a “manual operation”. When the command that is currently being processed is finished, the person 721 in charge of installation needs to return to the location of the MFP 105 with a device ID of “N007” to perform a manual operation. Therefore, a black circle is displayed in the “next operation” column. By performing display in advance such that the next operation is to be a manual operation as described above, the person 721 in charge of installation is able to easily determine whether to move onto an installation operation for the next MFP 105 or move to the location of the MFP 105 that requires a manual operation.

The button 1508 is a button for performing an automatic installation operation. When detecting that the button 1508 is pressed, the automatic installation program 450 starts the automatic installation operation for the own device. The processing of the automatic installation operation has been described above with reference to FIGS. 11A and 11B.

The button 1509 is a button for ending the automatic installation program 450.

As illustrated in the UI 1500, by displaying the operation state display list 1501, the UI of the MFP 105 at the location of which the person 721 in charge of installation is present allows the person 721 in charge of installation to understand the operation state of a different MFP 105 for which automatic installation is being performed. Accordingly, the person 721 in charge of installation is able to easily determine the device that the person 721 in charge of installation needs to operate next. Furthermore, since the operation state display list 1501 displays information such as a device name and a start date and time of automatic installation, the location of the MFP 105 may be easily obtained even if there are a large number of MFPs 105 for which automatic installation is being executed.

Furthermore, as described above, by classifying operation states in S1305 and S1306, the operation state of an MFP which requires a manual operation and an MFP whose operation state is error or warning, which requires the person in charge of operation to perform confirmation, is displayed in an emphasized manner. Furthermore, for the MFP which requires a manual operation for the next operation, a black circle is provided in the “next operation” column. Accordingly, the person 721 in charge of installation is able to easily determine which MFP 105 he/she needs to operate next. Information to be displayed in the operation state display list and a method for emphasized display are not limited to the example illustrated as the UI 1500.

FIG. 15B illustrates another example of an operation start screen that the automatic installation program 450 illustrated in the UI 1500 displays.

The UI 1550 includes an operation state display list 1551. The operation state display list 1551 differs from the operation state display list 1501 in that information “start order” is displayed. By displaying the start order instead of simply displaying the start date and time, the person 721 in charge of installation is able to easily determine the order in which installation was performed.

Information displayed is not limited to the above. Information with which the person 721 in charge of installation is able to easily determine an MFP, such as information on the installation location included in device setting information and information input by the person 721 in charge of installation, may be displayed. Furthermore, by displaying the number of MFPs 105 to be installed in this case, the number of MFPs 105 that are currently being installed, the number of MFPs 105 for which an automatic installation operation has not been started, and the like, the overall operation state in the case may be easily understood.

Furthermore, the operation state display list 1551 differs from the operation state display list 1501 in the order in which records are arranged. In the operation state display list 1551, the operation state of the MFP 105 that requires a manual operation or requires a person in charge of operation to perform confirmation, such as error or warning, is displayed in a higher position in the order. By finely classifying operation states in S1305 and S1306 as described above, various display modes may be achieved.

FIG. 15C illustrates an example of a UI that the automatic installation program 450 displays after an automatic installation operation starts. In particular, the UI detects that the button 1508 of the UI 1500 illustrated in FIG. 15A is pressed, and is displayed by the automatic installation program 450. A UI 1570 includes a text display region 1571 which displays an operation state of the own device. The text display region 1571 displays the operation state of the own device. By displaying the operation state of the own device and the operation state of a different MFP 105 in an independent manner as described above, the operation state of the own device may be easily understood.

As described above, according to the first embodiment, the case management server 107 manages operation state data, and the MFP 105 acquires and displays operation state data of a different MFP in the same case. Therefore, the person 721 in charge of installation is able to easily determine which MFP he or she needs to operate.

### Second Embodiment

In the first embodiment described above, by displaying on the UI of the MFP 105 the installation state of a different MFP 105 in the same case, the person 721 in charge of installation is able to easily determine which MFP 105 he or she needs to operate next. In a second embodiment, an example in which if a manual operation for the MFP 105 is only confirmation of the progress of an automatic installation operation, the operation may be performed at a different MFP 105, will be described. Since the system configuration and hardware configuration are similar to those in the first embodiment, explanation for those configurations will be omitted. The software configuration of a case management server program that runs at the case management server 107 in the second embodiment differs from that in the first embodiment.

### <Functional Configuration of Case Management Server Program>

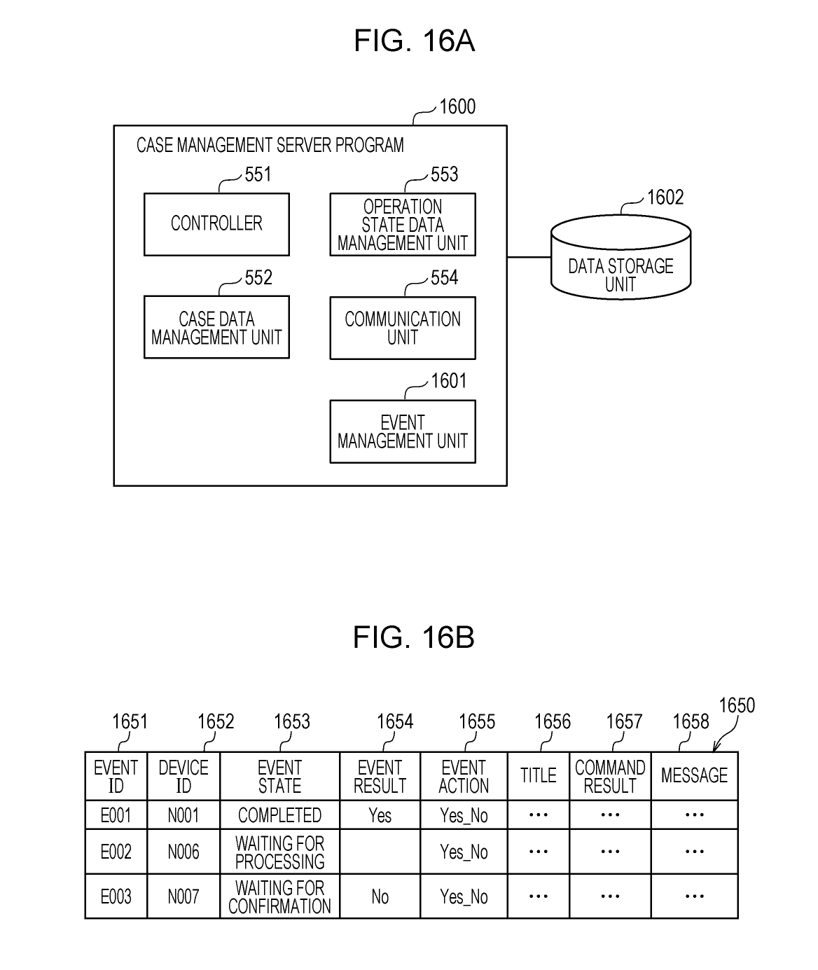

FIGS. 16A and 16B are diagrams illustrating an example of the functional configuration of a case management server program 1600, which runs on the case management server 107, and a data storage unit 1602. Hereinafter, only differences between the case management server program 1600 and the case management server program 550 will be explained.

Referring to FIG. 16A, an event management unit 1601 stores, deletes, and updates event data for the data storage unit 1602, which will be described later, in accordance with an instruction by the controller 551. Furthermore, the event management unit 1601, for example, acquires event data from the data storage unit 1602. The data storage unit 1602 manages an event data management table 1650, in addition to tables managed by the data storage unit 555.

### <Configuration of Event Data Management Table>

FIG. 16B illustrates an example of an event data management table managed by the data storage unit 1602. The table configuration of FIG. 16B is merely an example, and may have a table configuration different from the example provided below.

Referring to FIG. 16B, the event data management table 1650 includes columns 1651 to 1658. The column 1651 indicates an event ID. The column 1652 indicates an event ID. The column 1652 indicates the device ID of an MFP in which an event has occurred. The column 1653 indicates the processing state of an event, and a processing state, such as “waiting for processing”, “waiting for confirmation”, and “completed”, is entered. “Waiting for processing” indicates the state in which processing of an event has not been performed. “Waiting for confirmation” indicates the state in which an event has been processed by a different MFP 105.

“Completed” represents that processing to be performed in an event is completed and a processing result of the event is received at the MFP 105 in which the event has occurred. The column 1654 indicates a processing result of an event. In the case where an event is processed, a processing result of the event is stored in the column. The column 1655 indicates action of an event. The title of an event is stored in the column 1656. A processing result of a command is stored in the column 1657. A message is stored in the column 1658. The details of the contents stored in the columns 1655 to 1658 will be described later.

### <Case Creation Program>

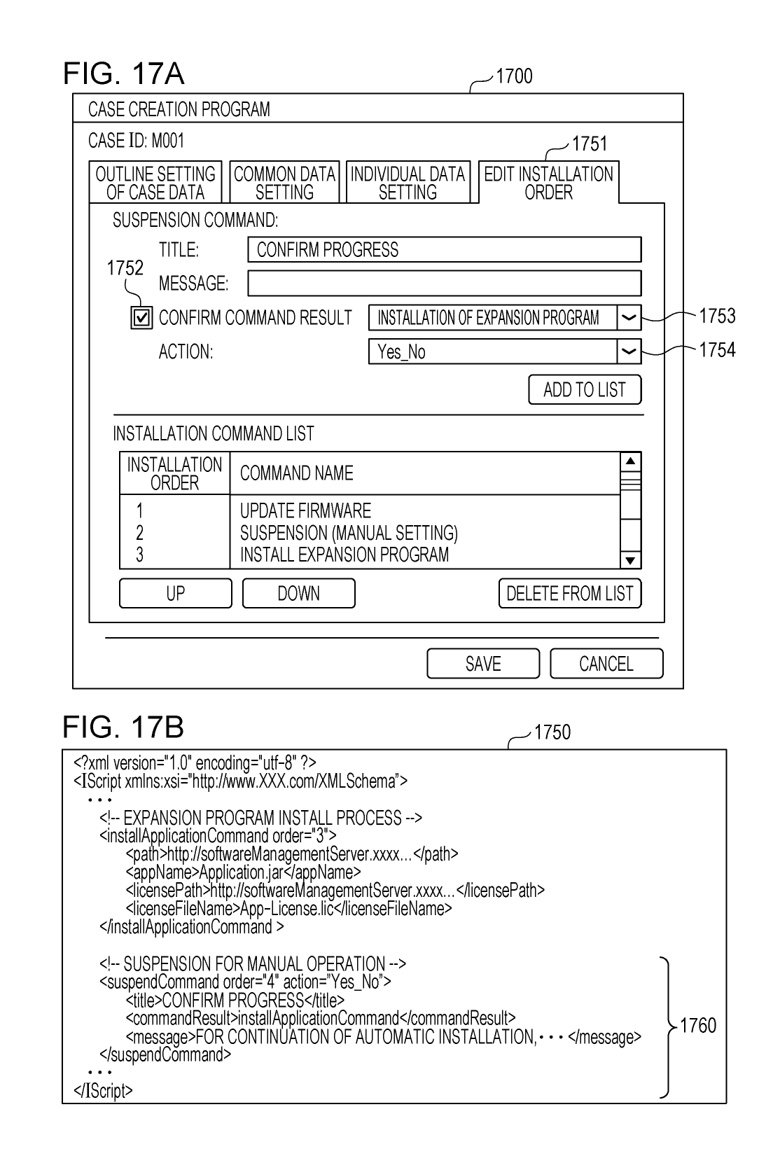

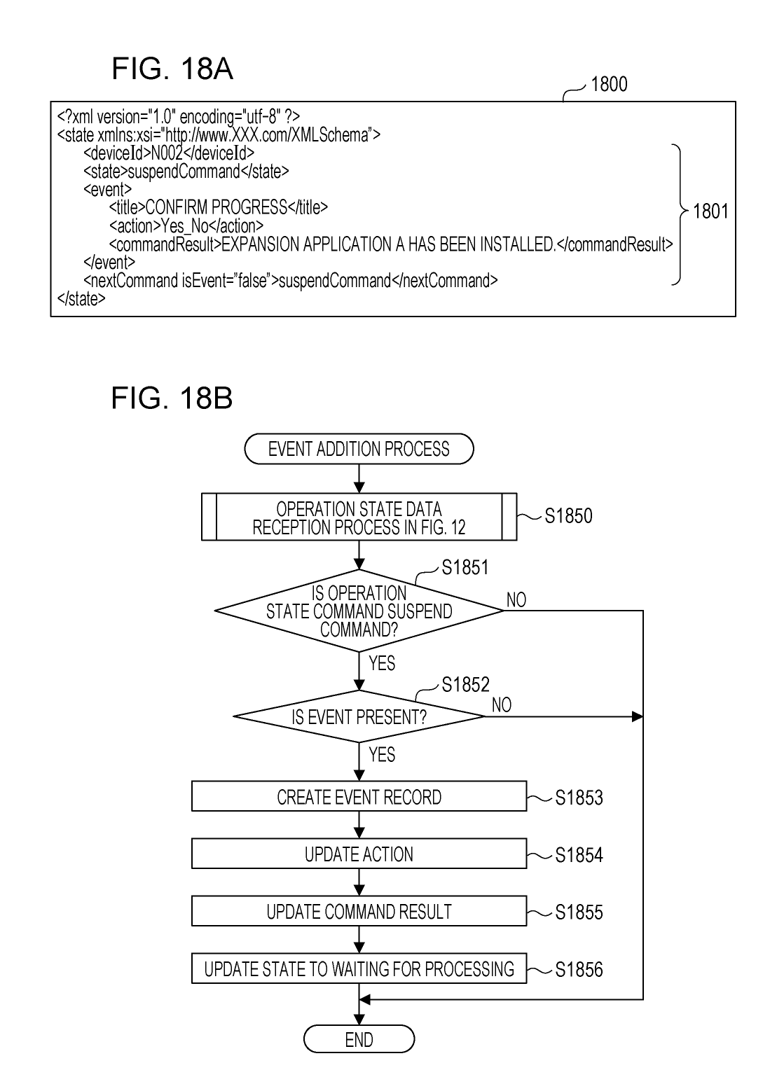

FIGS. 17A and 17B are diagrams for explaining an installation script in which an installation operation procedure for automatically executing installation of the case creation program 500 of the client computer 106 and the MFP 105 illustrated in FIG. 1, is described. In particular, FIG. 17A illustrates an example of a UI of the case creation program 500 of the client computer 106. The UI is operated when the case creator 720 performs the operation of S701. The UI is a UI for creating case data and is substantially the same as the UI 850 for creating case data, which has been explained in the first embodiment. Therefore, only differences will be described below.

Referring to FIG. 17A, a tab page 1751 of a UI 1700 includes controls 1752 to 1754, in addition to control including the tab page 854 of the UI 850. The controls 1752 to 1754 are controls for setting a suspension command. The control 1752 is a check box for setting, as the contents of a suspension command, whether or not a processing result of the command should be confirmed.

A combo box 1753 is a combo box for setting a processing result of a command that should be confirmed. The control 1754 is a combo box for setting an action. For example, in the state of the UI 1700, a suspension command indicates that there is a need to confirm a result of an install command for an expansion program and respond with Yes or No to a question as to whether or not to continue execution of the subsequent command. The way how to actually process the suspension command set in the UI will be described later.

### <Example of Installation Script>

FIG. 17B illustrates an example of an installation script in which an installation operation procedure for automatically executing installation of the MFP 105 is described. The installation script is substantially the same as the installation script 900 explained with reference to FIG. 9 in the first embodiment. Therefore, only different parts in a suspension command will be explained below.

Referring to FIG. 17B, an installation script 1750 includes a suspension command part 1760. The suspension command part 1760 is a command for suspending an automatic installation operation, and is defined by describing a <suspendCommand> tag. The <suspendCommand> tag includes an action attribute. An action is indicated by the action attribute.

As the value of the action attribute, the contents set in the combo box 1754 of the UI 1700 are set. A <commandResult> tag indicates which command result is to be confirmed. In this example, an installApplicationCommand, which represents a command for installation of an expansion program, is specified. As the value of the <commandResult> tag, the contents set in the combo box 1753 of the UI 1700 are set.

### <Example of Operation State Data>

FIGS. 18A and 18B are diagrams for explaining operation state data to be transmitted to the case management server 107 and an event addition process. In particular, FIG. 18A illustrates an example of operation state data that the automatic installation program 450 of the MFP 105 transmits to the case management server 107. The operation state data is transmitted to the case management server 107 by the automatic installation program 450 in the processing of S1104 explained above with reference to FIGS. 11A and 11B.

Operation state data 1800 is substantially the same as the operation state data 1150 illustrated in FIG. 11B explained above in the first embodiment. Therefore, only differences will be explained below.

Referring to FIG. 18A, the operation state data 1800 differs from the operation state data 1150 in that an event description part 1801 is provided and a <nextComamnd> tag includes an isEvent attribute.

The event description part 1801 indicates an event that may be processed at a different MFP 105 in the same case. A <title> tag indicates the title of an event. An <action> tag indicates an action. A <commandResult> tag indicates a processing result of a processed command. The processing result described here is a processing result of a command set in the combo box 1753 of the UI 1700. After transmitting the operation state data, the automatic installation program 450 regularly polls to the case management server 107 as to whether or not an event result is updated. In accordance with an event result received by polling, the automatic installation program 450 continues or stops the automatic installation operation.

### <Event Data Addition Process by Case Management Server Program>

FIG. 18B is a flowchart for explaining a control method for a management device according to this embodiment. In this example, a process of the case management server program 1600 to add event data is performed. The event addition process is performed after the operation state data reception process explained with reference to FIG. 12. That is, when the case management server program 1600 receives operation state data, the event addition process is performed. Individual steps are implemented when the CPU 301 executes the stored case management server program 1600. Hereinafter, the modules illustrated in FIGS. 5A and SB will be mainly explained.

In S1851, the controller 551 of the case management server program 1600 determines whether or not the operation state of the operation state data received in S1201 is a suspendCommand, which is a suspension command. When the controller 551 determines that the operation state is a suspension command, the process proceeds to S1852. When the controller 551 determines that the operation state is not a suspension command, the operation ends.

In S1852, the controller 551 of the case management server program 1600 determines whether or not an <event> tag representing an event is present in the operation state data received in S1201. When an event is present, the process proceeds to S1853. When no event is present, the operation ends.

In S1853, the event management unit 1601 of the case management server program 1600 issues an event ID, creates a new record in the event data management table 1650, in accordance with an instruction by the controller 551, and updates the event ID and a device ID. Then, the process proceeds to S1854.

In S1854, the event management unit 1601 of the case management server program 1600 updates the column 1655 of the event data management table 1650, in accordance with an instruction by the controller 551, and the process proceeds to S1855. For example, when the operation state data 1800 is received in S1201, the column 1655 in the record with a device ID of the column 1652 of “N002” in the event data management table 1650 is updated to “Yes No”.

In S1855, the event management unit 1601 of the case management server program 1600 updates the column 1656 of the event data management table 1650, in accordance with an instruction by the controller 551, and the process proceeds to S1856.

In S1856, the event management unit 1601 of the case management server program 1600 updates the column 1653 of the event data management table 1650 to “waiting for processing”, in accordance with an instruction by the controller 551, and the process ends.

<Classification process for Command by Automatic Installation Program>

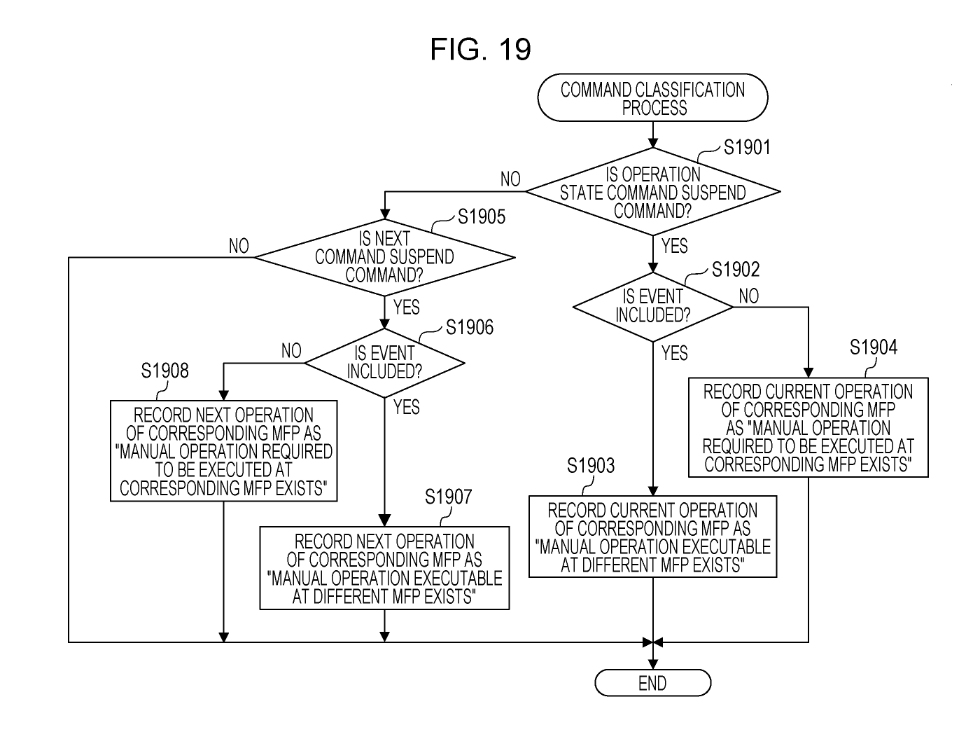

FIG. 19 is a flowchart for explaining a control method for an information processing device according to the second embodiment. In this example, the control method corresponds to an example of a command classification process by the automatic installation program 450 according to the second embodiment. The display process of the operation start screen explained above with reference to FIGS. 13A to 13C differs from that in the first embodiment in a command classification process. Therefore, only the command classification process will be explained below.

Furthermore, a difference between the operation state data list acquired in S1301 and that in the first embodiment is, regarding each piece of operation state data, equal to a difference between the operation state data 1800 and the operation state data 1150. That is, the existence of the event description part 1801 and the presence of the isEvent attribute in the <nextCommand> tag corresponds to the difference.

Since S1901 is equal to S1351, explanation for S1901 will be omitted.

In S1902, the operation state analysis unit 454 determines whether or not the operation state data includes an event. When the operation state analysis unit 454 determines that an event is included, the process proceeds to S1903. When the operation state analysis unit 454 determines that no event is included, the process proceeds to S1904.

In S1903, the processing execution unit 452 temporarily records that the current operation of the MFP 105 is a manual operation which may be executed at a different MFP. Then, the process ends.

In S1904, the processing execution unit 452 temporarily records that the current operation of the MFP 105 is a manual operation which needs to be performed at the location of the MFP 105. Then, the process ends. Since S1905 is the same as S1353, explanation for S1905 will be omitted.

In S1906, the operation state analysis unit 454 determines whether or not the next command in the operation state data includes an event. That is, the operation state analysis unit 454 determines whether or not the isEvent attribute in the <nextComamnd> tag is true. When the operation state analysis unit 454 determines that an event is included in the next command, the process proceeds to S1907. When the operation state analysis unit 454 determines that no event is included in the next command, the process proceeds to S1908.

In S1907, the processing execution unit 452 temporarily records that the next operation of the MFP 105 is a manual operation which may be executed at a different MFP 105. Then, the process ends.

In S1908, the processing execution unit 452 temporarily records that the current operation of the MFP 105 is a manual operation which needs to be performed at the location of the MFP 105. Then, the process ends.

### <Example of Operation Start Screen Displayed by Automatic Installation Program>

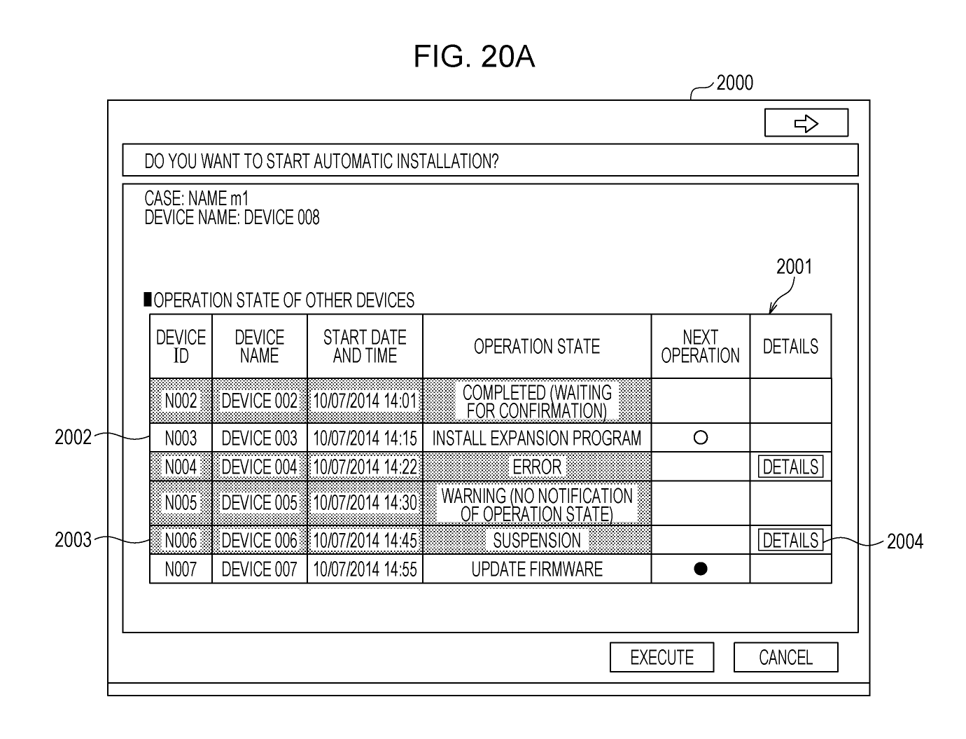

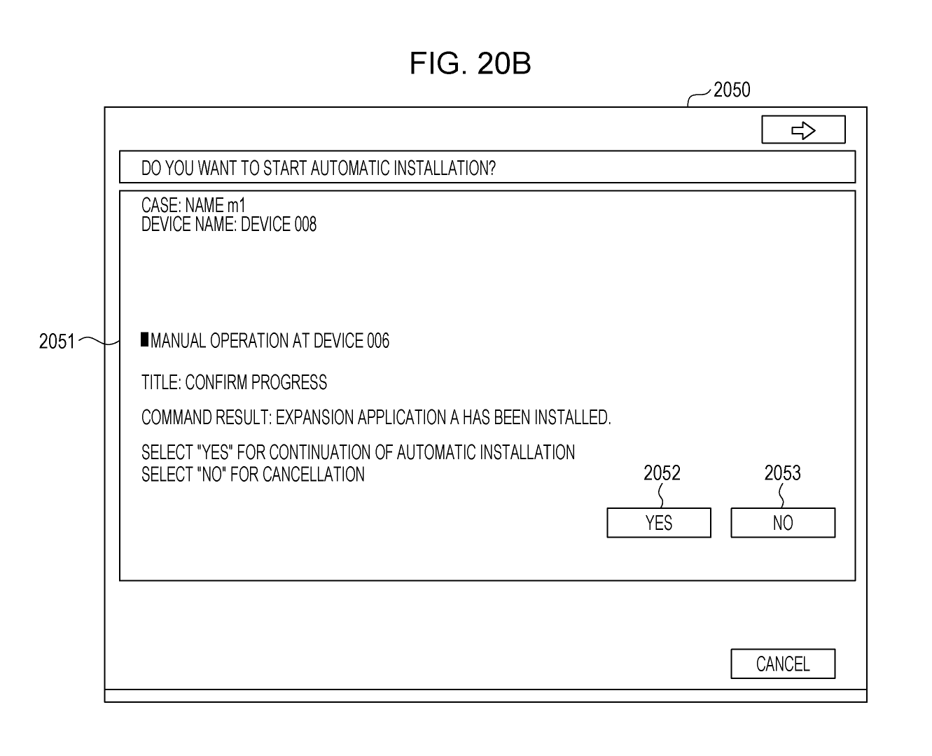

FIGS. 20A and 20B are diagrams illustrating examples of a UI screen displayed on the information processing device according to the second embodiment. FIG. 20A illustrates an example of an operation start screen displayed by the automatic installation program 450. The UI screen is displayed by the processing of S1309 explained with reference to FIG. 13A.

Referring to FIG. 20A, a UI 2000 is substantially the same as the UI 1500 explained in the first embodiment. Therefore, only differences will be described below.

In an operation state display list 2001, a single record indicates the operation state of an MFP. Only characteristic records in the second embodiment will be explained below.

A record 2002 indicates the operation state of the MFP 105 with a device ID of “N003”. The operation state is “install expansion program”. A white circle is displayed in the “next operation” column. This represents that the next operation is a manual operation which may be executed at a different MFP 105. This represents that the processing of S1907, in which a classification is made such that the next operation is a manual operation which may be executed at a different MFP, allows display to be different from the others. Accordingly, in the case where an operation is suspended at a different MFP, an operator is able to issue, at the different MFP that the operator is operating, an instruction to continue the operation of the corresponding MFP.

A record 2003 indicates the operation state of the MFP 105 with a device ID of “N006”. The operation state is “suspension”, which requires a manual operation. Therefore, the color of the record is changed and display is done in an emphasized manner. Furthermore, a detail button 2004 is displayed in the “detail” column. This represents that a manual operation may be executed at a different MFP 105 in the same case. That is, in the case of the UI 2000, an installation operation for the MFP with a device ID of “N006” may be performed at the UI of the MFP 105 with a device ID of “N008”. When detecting that the detail button 2004 is pressed, the UI controller 451 of the automatic installation program 450 displays a UI 2050.

FIG. 20B illustrates a UI for performing an installation operation for a different MFP. The UI is displayed when the detail button 2004 of the UI 2000 is pressed.

Referring to FIG. 20B, the UI 2050 includes a text display region 2051 and buttons 2052 and 2053. The text display region 2051 indicates the contents of a manual operation required for the MFP 105 with a device ID of “N006”. More specifically, the title of operation state data, a command result, and a message of the MFP 105 with a device ID of “N006” are displayed.

The button 2052 is a button for returning “Yes” as a result of an event to the case management server 107. When the UI controller 451 of the automatic installation program 450 detects that the button 2052 is pressed, the communication unit 455 of the automatic installation program 450 notifies the case management server 107 of “Yes” as the result of the event. In response to the reception of the notification, the event management unit 1601 of the case management server program 1600 updates the column 1654 of the event data management table 1650 to “Yes”.

The button 2053 is a button for returning “No” as the result of the event to the case management server 107. When the UI controller 451 of the automatic installation program 450 detects that the button 2053 is pressed, the communication unit 455 of the automatic installation program 450 notifies the case management server 107 of “No” as the result of the event. In response to the reception of the notification, the event management unit 1601 of the case management server program 1600 updates the column 1654 of the event data management table 1650 to “No”.

As described above, according to the second embodiment, in the case where a manual operation for a certain MFP 105 is only confirming the progress of an automatic installation operation, only by notifying a different MFP 105 of an event, the different MFP 105 that is becomes able to perform a manual operation.

### Third Embodiment

In the first embodiment, in the case where an error has occurred in the execution of a command as illustrated in FIG. 11A, an automatic installation operation is stopped. However, depending on the contents of a command, such as installation of an expansion application, even if an execution error has occurred, some commands may continue to be executed because the execution error does not affect the subsequent automatic installation operation. However, eventually, there is a need to manually install an expansion application. Therefore, in a third embodiment, an example in which even in the case where an error has occurred in the execution of a command, an automatic installation operation continues to be performed, and the contents of the error of the command may be confirmed from a different MFP 105, will be described.

Furthermore, an example in which even in the case where a command is successful in import of device setting information or even in the case where setting different from a device setting value to be set is performed due to rounding processing within the MFP 105, the contents may be confirmed from a different MFP, will also be described. The third embodiment differs from the first embodiment in an installation process in the automatic installation program 450 and display of an operation start screen. Since the other features are the same as those in the first embodiment, explanation for those same features will be omitted.

### <Installation Process by Automatic Installation Program>

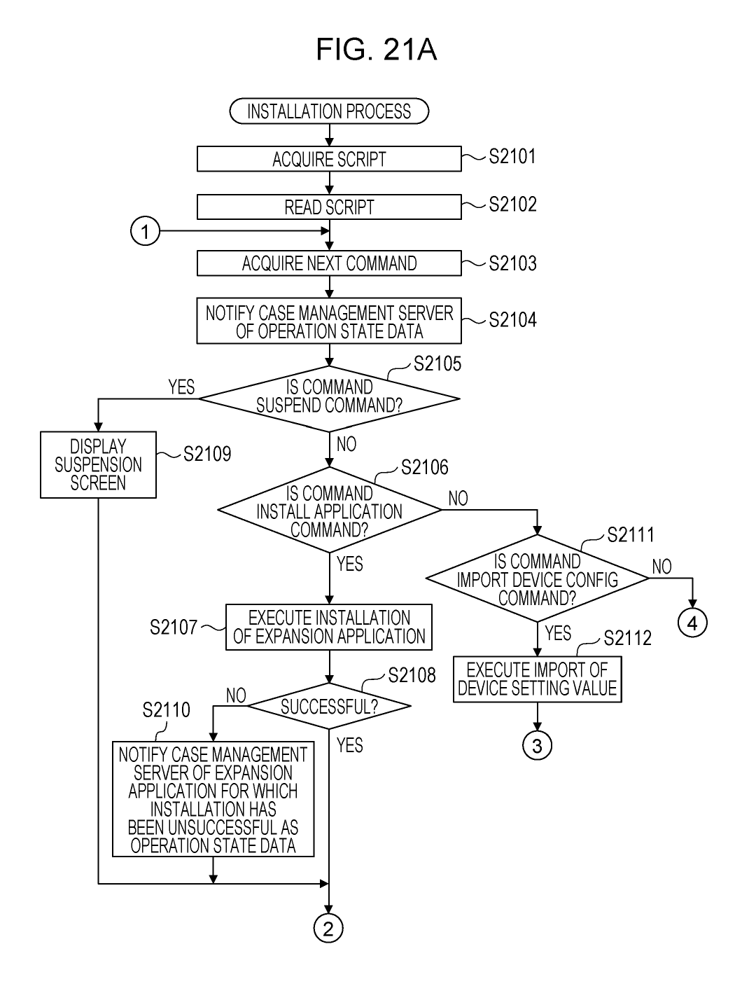

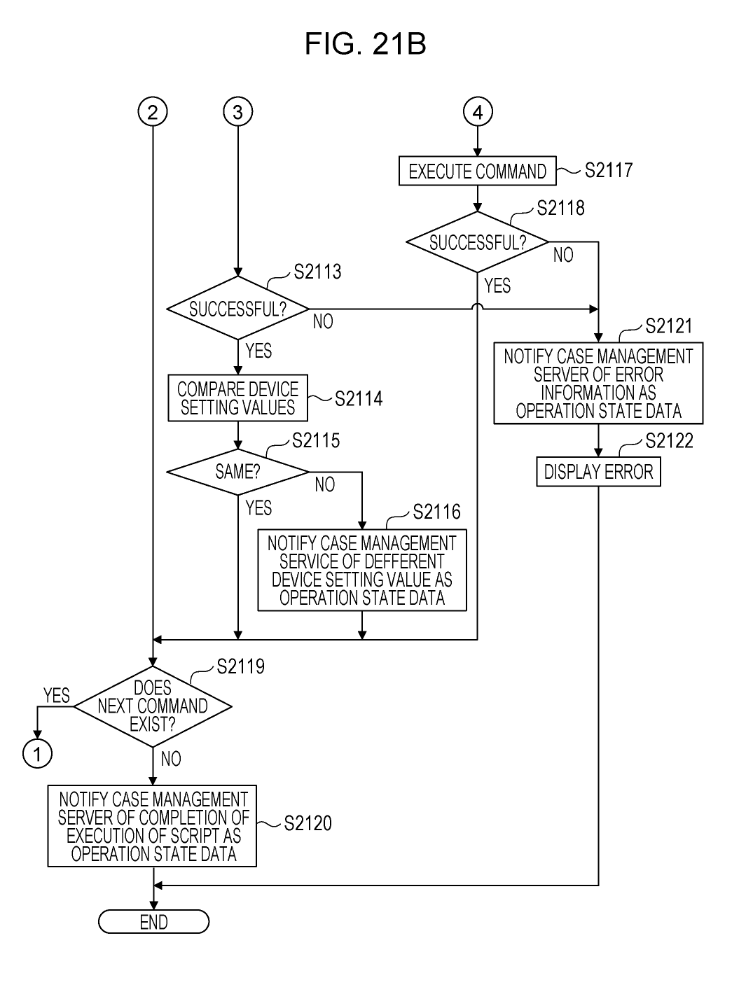

FIGS. 21A and 21B are flowcharts for explaining a control method for an information processing device according to the third embodiment. In this example, the control method corresponds to a processing example of an automatic installation operation performed by the automatic installation program 450. Only differences from the process illustrated in FIG. 11A will be explained. Processing from S2101 to S2105 is the same as the processing from S1101 to S1105. Therefore, explanation for the processing from S2101 to S2105 will be omitted. Individual steps are implemented when the CPU 201 executes the stored automatic installation program 450. Hereinafter, the modules illustrated in FIGS. 4A and 4B will be mainly explained.

In S2106, the processing execution unit 452 of the automatic installation program 450 determines whether or not a command to be processed is an installApplicationCommand, which is command for installing an expansion application. When the processing execution unit 452 determines that the command is an installApplicationCommand, the process proceeds to S2107. When the processing execution unit 452 determines that the command is not an installApplicationCommand, the process proceeds to S2111. In S2107, the processing execution unit 452 of the automatic installation program 450 performs installation of an expansion application, and the process proceeds to S2108.

In S2108, the processing execution unit 452 of the automatic installation program 450 determines whether or not the processing for the command performed in S2107 has been successful. When the processing execution unit 452 determines that the processing for the command has been successful, the process proceeds to S2119. Meanwhile, when the processing execution unit 452 determines that an error has occurred in the processing, the process proceeds to S2110. Since S2109 is the same as S1108, explanation for S2109 will be omitted.

In S2110, the communication unit 455 of the automatic installation program 450 notifies the case management server 107 of an expansion application for which installation has been unsuccessful as operation state data, and the process proceeds to S2119. Specifically, the name of the expansion application for which installation has been unsuccessful is included in the <detail> tag of the operation state data.

In S2111, the processing execution unit 452 of the automatic installation program 450 determines whether or not the command to be processed is an importDeviceConfigCommand, which is an import command of a device setting value. When the processing execution unit 452 determines that the command is an importDeviceConfigCommand, the process proceeds to S2112. When the processing execution unit 452 determines that the command is not an importDeviceConfigCommand, the process proceeds to S2117.

In S2112, the processing execution unit 452 of the automatic installation program 450 imports the device setting value through the setting management service 405, and the process proceeds to S2113.

In S2113, the processing execution unit 452 of the automatic installation program 450 determines whether or not the processing for the command performed in S2112 has been successful. When the processing execution unit 452 determines that the processing has been successful, the process proceeds to S2114. When the processing execution unit 452 determines that an error has occurred in the processing, the process proceeds to S2121.

In S2114, the processing execution unit 452 of the automatic installation program 450 compares the imported device setting value with the actually set device setting value through the setting management service 405, and the process proceeds to S2115.

In S2115, the processing execution unit 452 of the automatic installation program 450 determines, based on the result of the comparison in S2114, whether or not the imported device setting value is the same as the actually set device setting value. When the processing execution unit 452 determines that the device setting values are the same, the process proceeds to S2119. When the processing execution unit 452 determines that the device setting values are not the same, the process proceeds to S2116.

In S2116, the communication unit 455 of the automatic installation program 450 notifies the case management server 107 of a different device setting value as the operation start date, and the process proceeds to S2119. Specifically, the different device setting value is included in the <detail> tag in the operation state data.

Processing from S2117 to S2118 is the same as the processing from S1105 to S1106. Therefore, explanation for the processing from S2117 to S2118 will be omitted. Similarly, processing from S2119 to S2122 is the same as the processing from S1109 to S1112, and therefore explanation for the processing from S2119 to S2122 will be omitted.

### <Operation Start Screen of Automatic Installation Program>

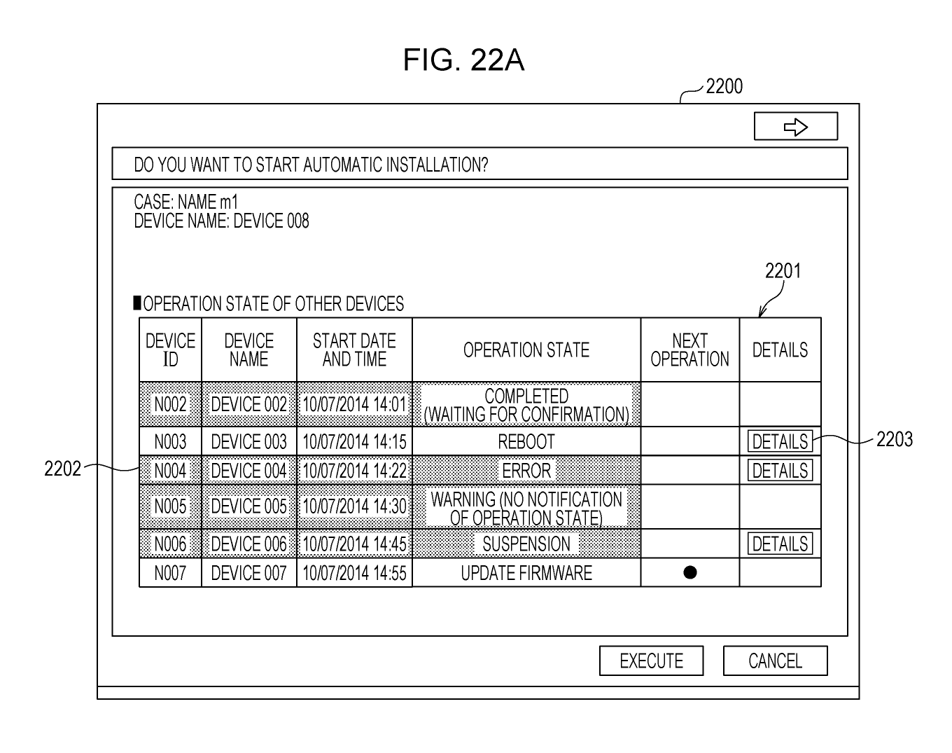

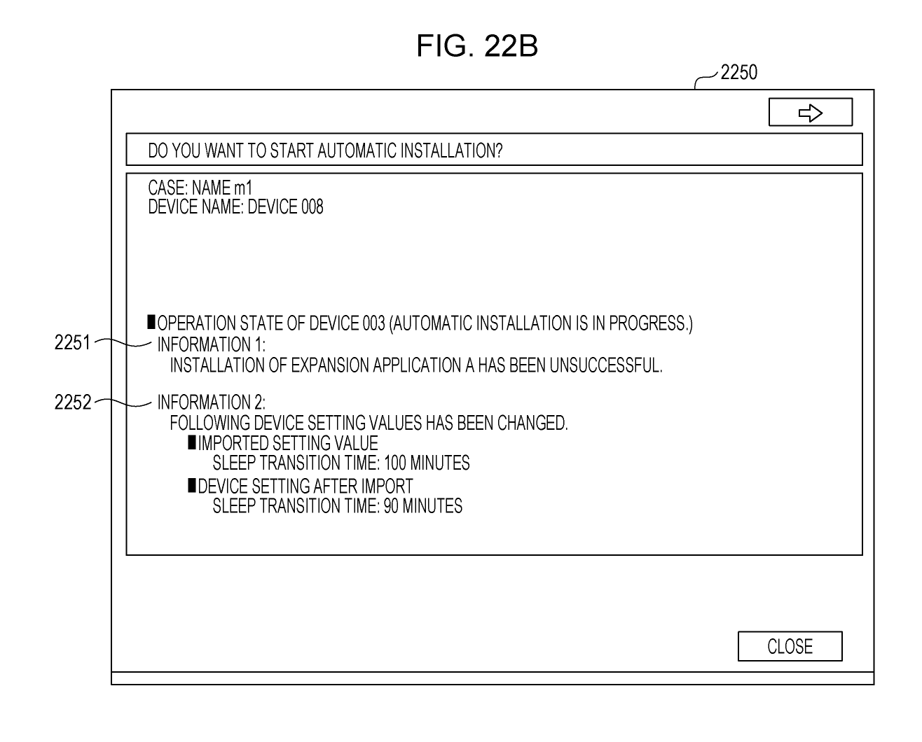

FIGS. 22A and 22B are diagrams illustrating a UI screen displayed on the information processing device according to the third embodiment. The UI screen in this example is an example of a UI of an operation start screen displayed by the automatic installation program 450. The UI is displayed by the processing of S1309 explained above with reference to FIG. 13A.

Referring to FIG. 13A, a UI 2200 is substantially the same as the UI 1500 explained above in the first embodiment. Therefore, only differences will be explained. In an operation state display list 2201, a single record indicates the operation state of an MFP. Only characteristic records in the third embodiment will be explained.

A record 2202 indicates the operation state of the MFP 105 with a device ID of “N003”. The operation state is “reboot”, which indicates that an automatic installation operation continues to be performed. Unlike the first embodiment, the automatic installation operation continues to be performed, and a detail button 2203 is displayed. The detail button 2203 is a button for displaying the details of the operation state of the MFP 105 with a device ID of “N003”.

FIG. 22B illustrates a UI which displays the details of the operation state of the MFP 105. In particular, the UI is an example of a UI displayed when the detail button 2203 is pressed.

Referring to FIG. 22B, a UI 2250 includes a text display region 2251 and a text display region 2252.

The text display region 2251 indicates that an error has occurred in an install command of an expansion application. This represents the contents notified to the case management server 107 in the processing of S2116 explained above with reference to FIG. 21B.

The text display region 2252 indicates the imported device setting value and the actually set device setting value in the import command for a device setting value. This represents the contents notified to the case management server 107 by the processing of S2110 explained in FIG. 21A. Accordingly, even in the case where a command is successful or even in the case where setting different from the device setting value to be set is performed due to rounding processing within the MFP, the contents may be confirmed from a different MFP.

As described above, according to the third embodiment, even in an error has occurred in the execution of a command, depending on the command, an automatic installation operation continues to be performed, and the contents of error information of the command may be confirmed from a different MFP.

The present invention is also attained by processing in which a program which implements one or more functions according to the foregoing embodiments is supplied to a system or an apparatus via a network or a storage medium and one or more processors in a computer of the system or apparatus reads and executes the program. Furthermore, the present invention may also be attained by a circuit (for example, an ASIC) implementing one or more functions.

According to the foregoing embodiments described above, even in the case where a person in charge of installation moves away from the location of an information processing device for installation operations for a plurality of information processing devices, the person in charge of installation may confirm the operation state of the information processing device.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-024638, filed Feb. 10, 2015, which is hereby incorporated by reference herein in its entirety.

What is claimed is:

1. An information processing device which communicates with a management device, the information processing device comprising:
an execution unit configured to execute a predetermined setting in accordance with case information acquired from the management device;
a first notification unit configured to notify the management device of an operation state executed by the execution unit; and
a controller configured to acquire an operation state of a different information processing device updated by the management device and display the acquired operation state on a display unit.

2. The information processing device according to claim 1, further comprising:
a reception unit configured to receive an instruction for the operation state of the different information processing device displayed on the display unit; and
a second notification unit configured to notify the management device of the received instruction for the different information processing device.

3. The information processing device according to claim 1, wherein the controller displays error, warning, suspension, and waiting for confirmation for confirming an operation result, as an operation state, in an identifiable manner on the display unit.

4. The information processing device according to claim 3, further comprising:
a third notification unit configured to notify a different information processing device whose operation state is suspension of an event indicating an instruction for continuation.

5. The information processing device according to claim 1, wherein the controller displays a list of operation states of preceding different information processing devices on the display unit before the predetermined setting is performed in accordance with the case information.

6. The information processing device according to claim 1, wherein the controller acquires error information of a different information processing device whose operation state acquired from the management device is error and displays the acquired error information on the display unit.

7. The information processing device according to claim 5, wherein the controller displays in the list information identifying a different information processing device for which the operation state acquired from the management device is to be the next operation.

8. The information processing device according to claim 5, wherein the controller displays in the list information identifying a different information processing device for which the operation state acquired from the management device is to be the next operation in an order different from an operation start order.

9. The information processing device according to claim 3, wherein suspension is an operation state which indicates that a manual setting by an operator is required.

10. A management device which communicates with a plurality of information processing devices, the management device comprising:
a management unit configured to store and manage case information to be set for the plurality of information processing devices and case information updated in accordance with a response from any of the information processing devices; and
a response unit configured to respond with case information requested from any of the information processing devices.

11. The management device according to claim 10, wherein the management unit updates an operation state indicating suspension to contents indicating continuation, in accordance with an event notified from any of the information processing devices.

12. A control method for an information processing device which communicates with a management device, the control method comprising:
an execution step of executing a predetermined setting in accordance with case information acquired from the management device;
a notification step of notifying the management device of an operation state executed in the execution step; and
a control step of acquiring an operation state of a different information processing device updated by the management device and displaying the acquired operation state on a display unit.

13. A control method for a management device which communicates with a plurality of information processing devices, the control method comprising:
a management step of storing and managing case information to be set for the plurality of information processing devices and case information updated in accordance with a response from any of the information processing devices; and
a response step of responding with case information requested from any of the information processing devices.

14. A non-transitory computer-readable medium storing therein on which a program for causing a computer to function as an information processing device which communicates with a management device, the information processing device comprising:
an execution unit configured to execute a predetermined setting in accordance with case information acquired from the management device;
a first notification unit configured to notify the management device of an operation state executed by the execution unit; and
a controller configured to acquire an operation state of a different information processing device updated by the management device and display the acquired operation state on a display unit.

15. A non-transitory computer-readable medium storing therein on which a program for causing a computer to function as a management device which communicates with a plurality of information processing devices, the management device comprising:
a management unit configured to store and manage case information to be set for the plurality of information processing devices and case information updated in accordance with a response from any of the information processing devices; and
a response unit configured to respond with case information requested from any of the information processing devices.
